(19) United States
(12) Patent Application Publication
(10) Pub. No.: US 2013/0034322 A1
(43) Pub. Date: Feb. 7, 2013

(54) OPTICAL WAVEGUIDE AND SEMIFINISHED PRODUCT FOR THE PRODUCTION OF AN OPTICAL WAVEGUIDE HAVING OPTIMIZED DIFFRACTION PROPERTIES

(71) Applicants: Matthias Auth, Essen (DE); Jürgen Rosenkranz, Jena (DE); Jörg Kotzing, Jena (DE); Wolfgang Hämmerle, Jena (DE); Lothar Brehm, Jena (DE)

(72) Inventors: Matthias Auth, Essen (DE); Jürgen Rosenkranz, Jena (DE); Jörg Kotzing, Jena (DE); Wolfgang Hämmerle, Jena (DE); Lothar Brehm, Jena (DE)

(73) Assignee: J-PLASMA GMBH, Jena (DE)

(21) Appl. No.: 13/642,026

(22) PCT Filed: Oct. 26, 2011
(86) PCT No.: PCT/EP2011/068795

§ 371 Date: Oct. 18, 2012

(30) Foreign Application Priority Data
Nov. 4, 2010 (DE) 10 2010 050 429.7
Jan. 24, 2011 (DE) 10 2011 009 242.0

(51) Int. Cl. G02B 6/028; G02B 6/02; B05D 5/06; G02F 1/035

(52) U.S. Cl. 385/2; 385/124; 385/123; 427/163.2; 427/569

(57) ABSTRACT

The invention relates to an optical waveguide and a semifinished product for producing an optical waveguide having optimized diffraction properties, comprising a trench structure that has a radius-dependent graded refractive index curve and/or a concentric depressed refractive index profile within a core zone (2) and/or within a cladding zone (4). In one embodiment of the optical waveguide and semifinished product, the structure is formed from a succession of differently doped regions containing dopants that are introduced into a base matrix and lower and/or increase the refractive index.

The invention relates to an optical waveguide and a preform for the production of an optical waveguide with optimized bending properties according to claim 1 and a method for manufacturing an optical waveguide, and a method for the manufacturing of a semifinished optical waveguide with optimized bending properties according to claims 7, 8 and 9.

The optical properties of an optical waveguide are also dependent, inter alia, on its bending characteristics. The degree of influence resulting from such bending, and the impact the bending of an optical waveguide has on its optical properties is referred to as the bending sensitivity. This is a very important parameter especially with respect to the applications of the optical waveguide. Optical waveguides with a high sensitivity to bending are preferably used for optical sensors intended to detect and measure mechanical deformations. On the other hand, optical waveguides intended to be used for the transmission of messages and data should have as low a bending sensitivity as possible, because in this case the waveguide should be influenced, as little as possible by the run of the waveguide.

It turns out, however, to be difficult to plan in advance the exact degree of bending sensitivity for the design of the optical waveguide or to adjust this specifically from the outset in the manufacturing process in order to match the environmental conditions and the intended application.

In EP216638610FS, US20100254653/Draka and EP2102691/Coming, fiber designs are described which produce a certain bending sensitivity. This bending sensitivity is not adjustable and is in many cases not appropriate the application.

In the publication “near zero bending loss in a double-trenched bend insensitive optical fiber at 1550 nm,” a twofold trench structure is described for single-mode fibers. The disadvantage of this disclosure is the lack of adjustability of the targeted bending sensitivity. Moreover, it concerns single-mode fibers, whereby the multi-mode aspect is not taken into account per se. Another disadvantage is the indispensable use of boron as a dopant.

Therefore, the Object is to provide an optical waveguide and preform for the production of an optical waveguide where, depending on the later planned application, the bending sensitivity is optimally adjusted in advance, and which thus offers exactly predictable bending optimized properties. It should be particularly ensured that waveguides with only a low bending sensitivity offer a high transmission bandwidth that meets an international standard of at least OM 3 or preferably OM 4 and higher. For optical waveguides having a high bending sensitivity, on the other hand, it needs to be ensured that the aperture, wavelength spectrum, core diameter and outer diameter have as high numerical values as possible that are best suited to the particular application. Moreover, it should also be possible to so design the variable parameter that it is also possible to influence one or more of the above parameters independently.

The object is achieved with an optical waveguide and a preform for the manufacture of an optical waveguide with optimized bending properties with the characteristics of claim 1. The optical waveguide and the preform contain a trench fine structure with a radius-dependent doping profile. The doping profile ensures a gradient-like distribution of the refractive index within a central zone on the one hand and/or on a concentric refractive index trench profile within an outer zone on the other.

The inventive optical waveguide or the preform for the production of the former, as the case may be, is thus doped so that at least a refractive index profile is established in the core or the cladding or both in the core and in the cladding. This is a gradient-like distribution of the refractive index in the core. This depends on the radius and decreases steadily from zero to the core-cladding interface. The doping is effected in such a way that a concentric refractive index profile is established within the cladding zone. This means that there are alternating concentric areas with lower and higher refractive index in the cladding zone. The areas in which the refractive index is relatively low are referred to as “trenches” so that in the area of the cladding zone, one also refers to a “trench structure” or lamellar structure when referring to the radial refractive index level.

In the area of the cladding zone, the refractive index trench profile is determined by a lower and an upper envelope curve and an oscillating zone function between the lower and the upper envelope curve.

The zone function thereby determines the periodicity of the refractive index trench structure as well as the width of the trenches and the widths of the levels lying between, but also the shape of the trenches themselves, in principle, any function with a periodic curve and any periodic form can be used as the zone function. Such functions can be long, especially with respect to their periods, and are characterized by the distances between the zero points and the values of the maxima or the minima, i.e., by their amplitude. Zone functions come especially in the form of sinusoidal curve functions, but above all in the form of rectangular functions or sawtooth functions. The zone function thereby generates the trench width, the trench distances, i.e., the width of the steps existing between the trenches, and the trench harms in the refractive index profile in the outer zone.

The maximum possible trench depths and the maximum heights of the steps and thus in a sense the “amplitude” of the trenches are defined, by the envelope curves. The envelope curves do not determine the size of each individual amplitude of the zone function in every case, although it is of course possible to define the envelope curves as discrete point sequences whereby each point of the point sequence is associated with an at least local maximum or an at least local minimum of the zone function.

In general, however, the envelope curves do specify lower and upper limits for the maxima and minima of the function area.

However, the zone function earl also be a function of the radius. This means that the distances between any two intersection points of the zone function may have the refractive index value of the glass matrix but may not have a different distance.

However, this is not a real deepening in the area of the cladding zone. Rather, this refers to the fact that the concentric trench fine structuring within the cladding zone comprises a discontinuous refractive index distribution depending on the radius, whereby the refractive index corresponding to the concentric doping profile moves or oscillates in a stepped, gradient and/or rectangular manner.

The trench fine structuring thus leads to a structure within the cladding zone, which is reminiscent of the cross-section of the concentric rings of a tree trunk or a pyramid cake. The trenches are arranged in the entire cladding zone and not only in the vicinity of the core. The trench fine structuring is particularly visible through a fiber cross-section in the form of concentric rings within the cladding zone illuminated by tight and enlarged by means of a microscope or other means.

In an advantageous embodiment, the trench fine structuring is formed by a series of differently doped areas comprising refractive index lowering dopants and/or refractive index increasing dopants within a basic matrix. In principle in such an embodiment, only a base material needs to be used to which changing dopants only need to be applied in order to produce the desired refractive index profile.

The basic matrix is advantageously formed as a quartz glass matrix. As dopants, elements of the first to the seventh main group, rare earth elements, metals, and/or semi-metals and/or compounds of the said elements are used.

In a targeted embodiment, the refractive index, modulation of the trench profile displays increasing depth as a function of the radius. This means that the height of the oscillation, i.e., the size of the refractive index discontinuity, increases, whereby the refractive index lowering areas display a decreasing refractive index with increasing radius.

The depth of the trench profile increases therefore either linearly or gradually. In the case of a linear increase, the increase is by a constant factor, and thus the increase is independent of the radius. In the case of a gradual increase, the increase is itself is a function of the radius.

In a further embodiment, the refractive index trench profile has directionally dependent interruptions and recesses. In this variant, the concentric trenches are partly, i.e., sectorally, interrupted at these points so there is no refractive index decrease.

The following process steps are performed in a method for producing an optical waveguide or a preform for an optical waveguide with optimized bending properties.

Initially a matrix consisting of a silica core is provided. The core is doped with dopants varying the refractive index. This provides a core refractive index profile. Subsequently, an outer coating process is carried out, whereby a core casing having a shell-shaped doping profile is applied.

A repeated collapsing is performed in another method for producing an optical waveguide or a preform for an optical waveguide with optimized bending properties. Thus, the following process steps are carried out:

A first substrate tube is provided. Thereafter, a first layer is deposited on the inside of the first substrate tube to form a core. Subsequently, the first substrate tube is collapsed and removed so that the core is now exposed. Another substrate tube is now provided. A doped layer is deposited on the inside of this additional substrate tube. The further substrate tube is removed and the doped layer is collapsed onto the core. In a corresponding manner, additional substrate tubes are now prepared in which further layers may be deposited, and which are now collapsed successively on the already finished body of the optical waveguide or preform.

The following process steps are performed in another method of manufacturing an optical waveguide and a preform for an optical waveguide with optimized bending properties:

First a substrate tube is provided. Then successively differently doped layers are deposited in the interior of the substrate tube, whereby a core is formed. The substrate tube is then removed and the core exposed. Then successively differently doped outer lavers are deposited.

In a further embodiment of the process, first a substrate tube is provided. Then successively differently doped layers are deposited in the interior of the substrate tube, or from the outside, thereby forming a thicker layer. The substrate tube is then removed. The result is a tube consisting of doped quartz glass. At least certain sectionally determined tube segments are removed from this. This tube is collapsed, onto a suitable substrate. This substrate can be either further coated or receive more layer structures using the jacketing process. A structure can thus be achieved in an appropriate way.

The aforementioned separation and collapsing steps can be performed with substrate tubes, which are provided with recesses. This enables the above-mentioned interruptions within the refractive index profile to be obtained.

The layered structures may also be generated by the use of the vacuum gas phase separation method, i.e., the so-called OVD method, preferably the plasma assisted OVD method, flame method, smoker method and/or CVD process, preferably the MCVD process.

In the case of quartz glass, doping with fluorine to produce the trenches using the POVD method is particularly useful.

Germanium, however, is advantageously introduced by means of the MCVD method to produce the core in the bend-insensitive fiber.

In the case of preforms, a heat treatment between the individual process steps is particularly advantageous.

The preform or the final fiber can only be produced by an appropriate combination of the previously listed methods or process steps.

The optical waveguide and the preform for the former's production could be related radially dependent on the location in at least one of the following properties: refractive index, polarization, mode distribution, attenuation/absorption, structure of the trenches, bending sensitivity, mode selection, propagation of the light, glass viscosity, coefficient of expansion and/or the phonon oscillations.

This dependence can also vary along the length of the fiber or preform.

A lamellar trench structure of at least two trenches is provided.

The refractive index in the light-guiding core is increased in comparison with the reference refractive index, and has an at least partially gradual and/or at least sectionally sudden change, preferably an increase.

The trenches and/or the respective layer structure subsequent to a trench ma be independently arranged with respect to one another in terms of their depth or height with respect to the refractive index, trench shape and trench graduation, width and/or number as well as their spacing.

The trenches and/or the respective layer structure subsequent to a trench may also be arranged, with respect to one another in a fixed relationship with respect to their depth or height (refractive index), trench-shape or trench graduation, width and/or number as well as their spacing.

In a preferred embodiment, the fine structure adjoining the care begins with a refractive index lowering trench structure.

In a further embodiment, a layer with the refractive index of the glass matrix adjoins the core

The maximum trench depth of the individual trenches and/or the respective layer structure following a trench in the radial direction may be described by means of a parabola-like or linear function.

The lamellar structure is based on glass, this is at least partially obtained with individual trench depths and/or trench heights by doping the glass preferably by means of at least one of the following elements: F, P, Al, Ge, B, Yb, Nb, Ag, Au, Cu, Ni, Ta, Zr, Sn, Zn, Hg, Ru, Rh, Os, Ro, W, Ti, Al, In, Ga, Nb, La, Sm, Ce, B, P, Sr, Ba, Mo, Cr, Fe, Co, Se, Mn, Ge, V, In, Bi, Pt, Pd, Tc, V, Pb, N.

Fiber lasers offering particularly good properties with respect to their optical wave guiding can be produced by doping at least one layer with a laser-active element.

The geometry of the core and/or individual layers can differ from the circular symmetry. Thus it is also possible that individual layers are molded with an angularity. This has advantages in terms of mode mixing using these fibers as a fiber laser.

But even in the case of passive fibers, angularity may be particularly suitable when, for example, fibers with a high packing density may be required.

The lamellar structure is formed in the case of plastic optical waveguides by the use of various materials, preferably plastics.

A fine structure is formed by the arrangement of the trenches and/or the layer structures following the trenches.

The lamellar structure can be interrupted in at least one trench structure preferably by at least partially sectional radial recesses.

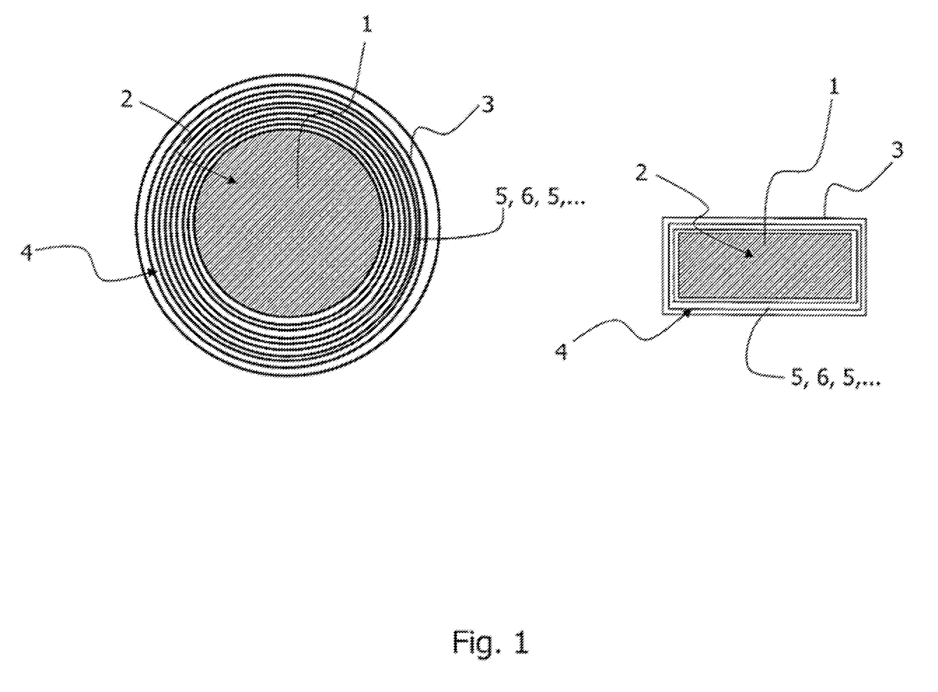

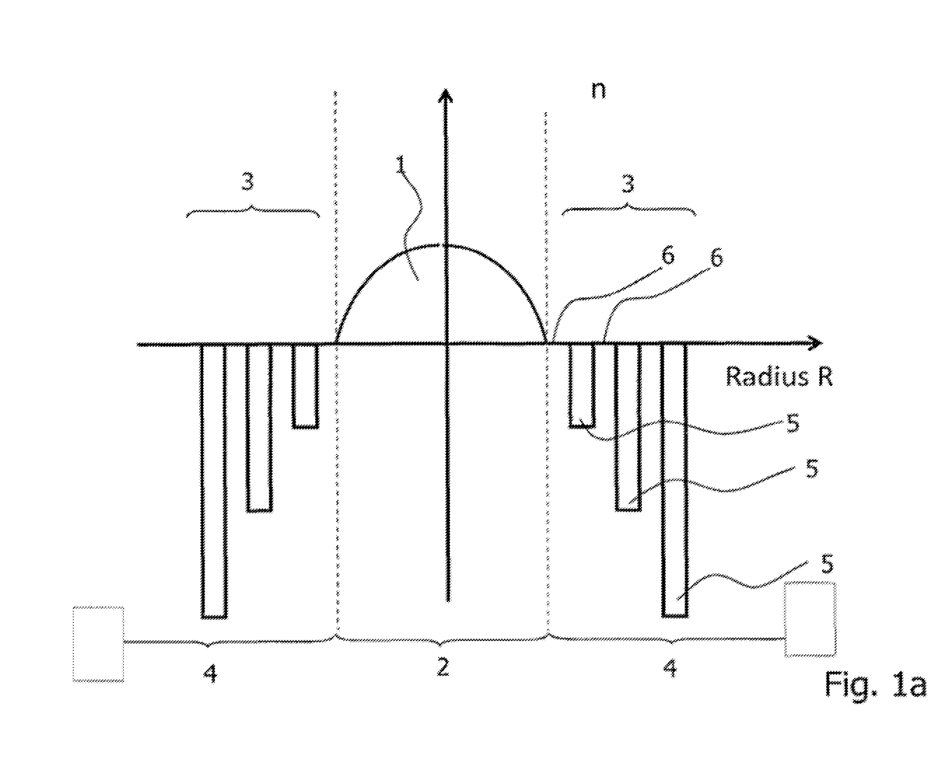

The invention will be described below in more detail with reference to exemplary embodiments. The same reference numerals will be used for the same or similar parts. The attached FIGS. 1 to 37 are used to illustrate these embodiments.

They figures are as follows:

FIG. 1 is a diagram showing the refractive index profile of a first trench fine structuring of the refractive index as a function of fiber radius with a gradient structure in the core, and a trench structure in the cladding zone,

FIG. 1a shows an exemplary cross-section of an optical waveguide with the above-mentioned trench fine structuring,

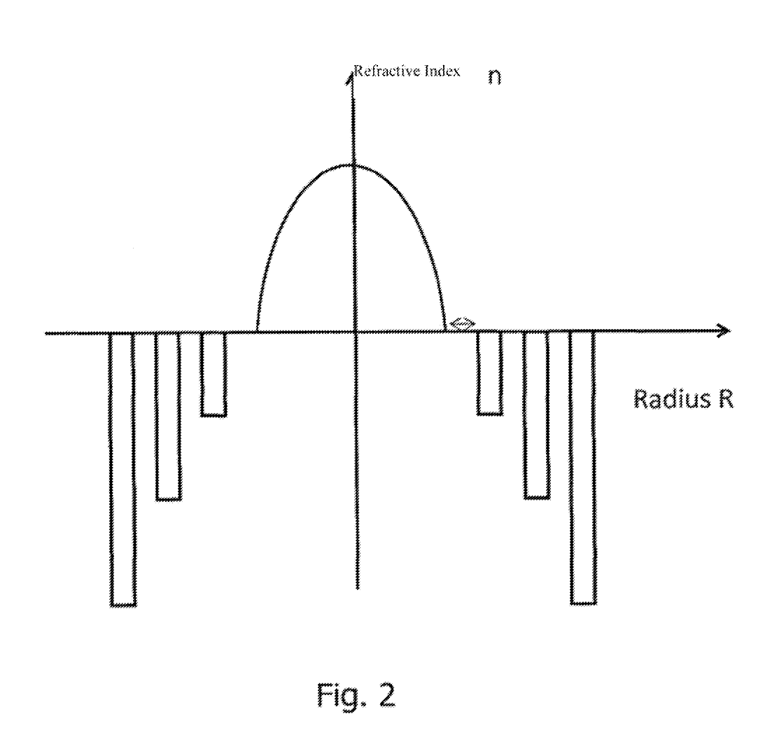

FIG. 2 shows a diagram with the refractive index profile shown in FIG. 1 of the trench fine structuring of the refractive index with an increased core refractive index,

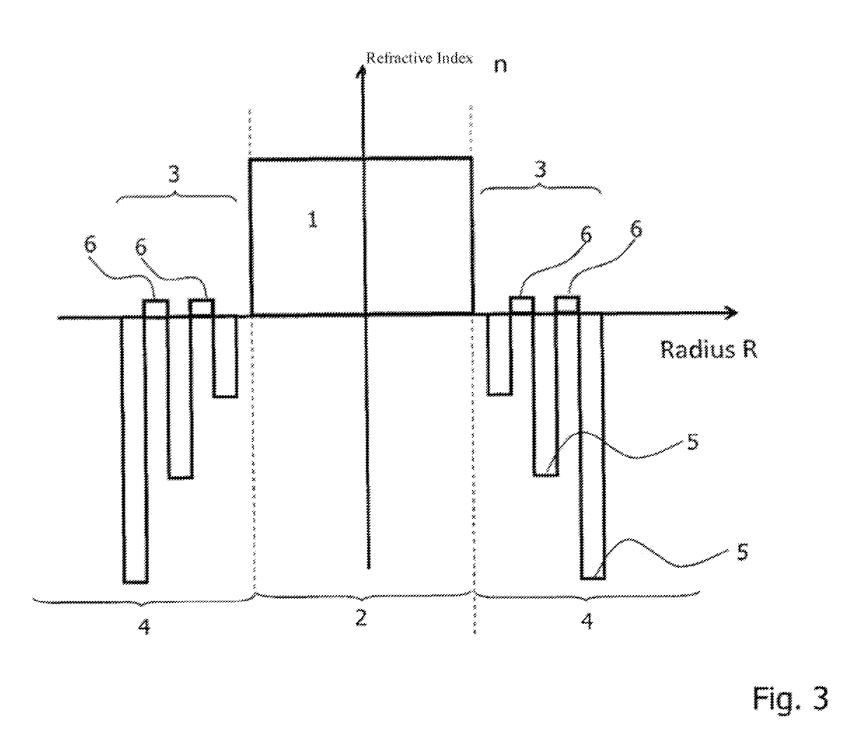

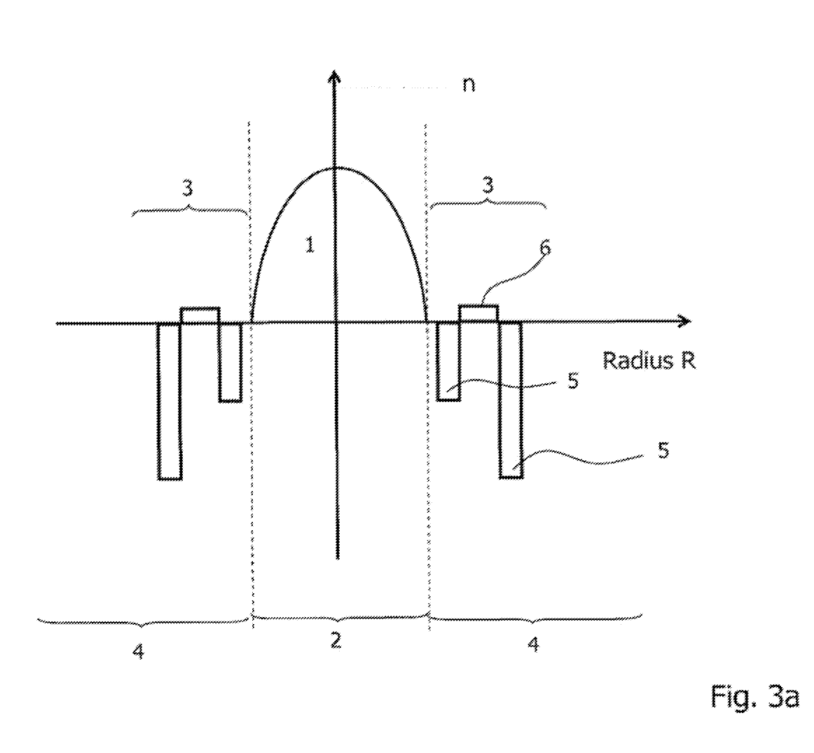

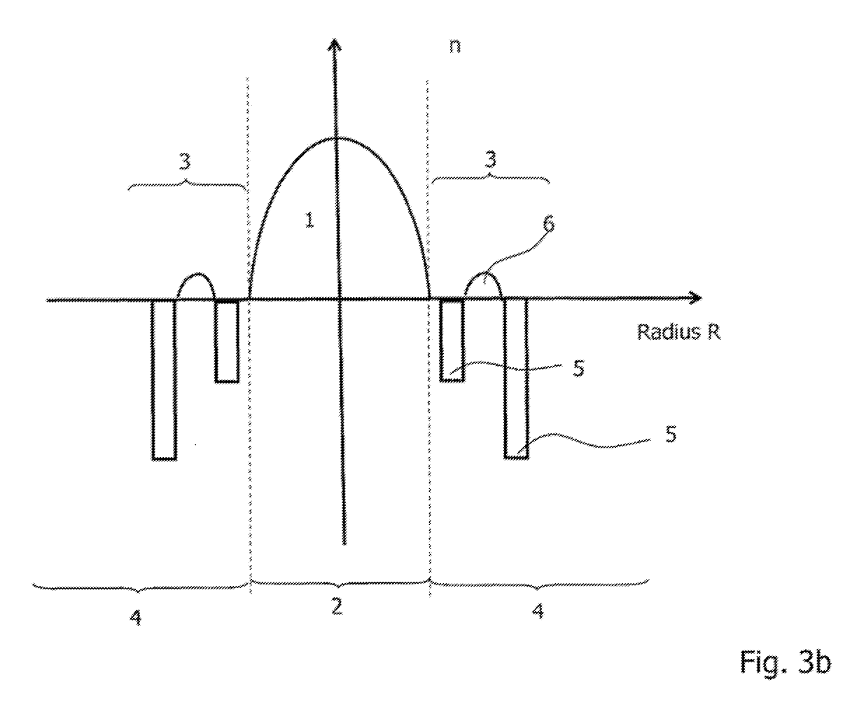

FIG. 3 shows a diagram with a core with a constant refractive index profile with a secondary increased refractive index cladding.

FIG. 3a is a diagram with a core with a graded refractive index profile with a secondary increased refractive index cladding,

FIG. 3h shows a diagram with a graded profile curve in increased refractive index cladding.

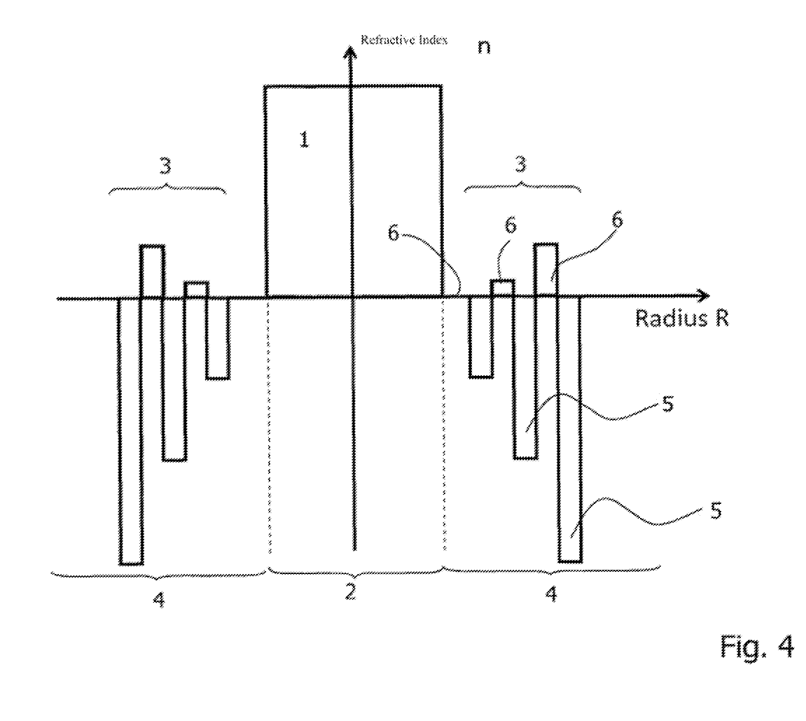

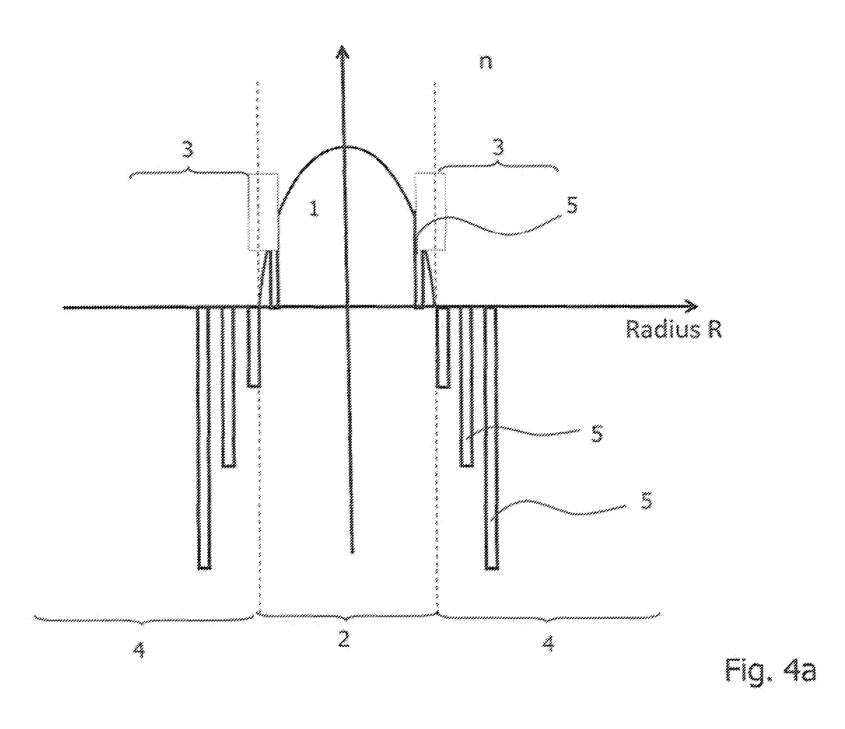

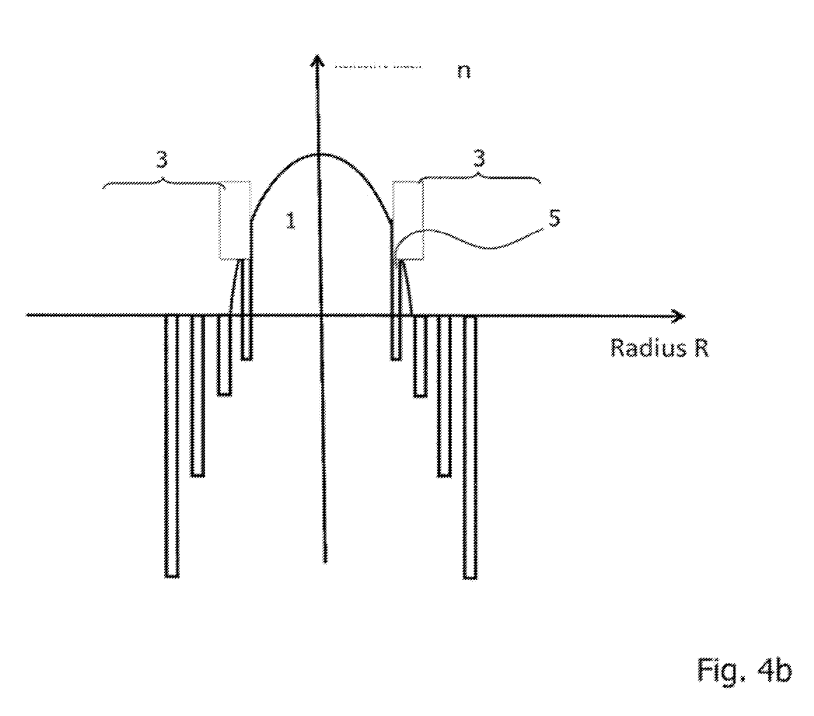

FIG. 4 shows a diagram of a trench fine structuring with a gradient-less increased refractive index core and a trench structure in the cladding zone,

FIG. 4a shows a diagram with a trench structure in the core,

FIG. 4b shows a diagram with an additional decreased refractive index trench structure in the core,

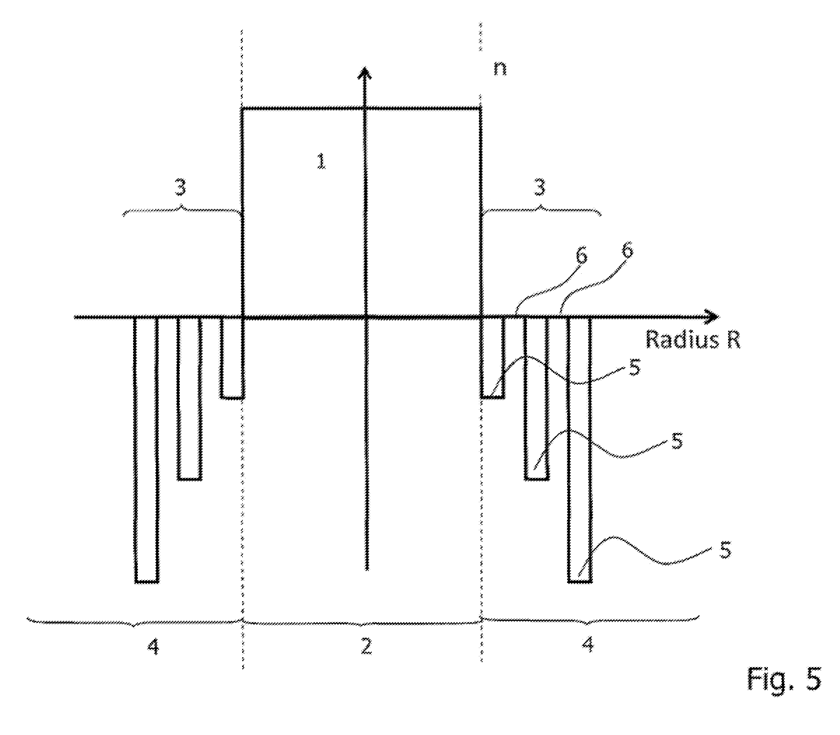

FIG. 5 shows a trench fine structuring without primary cladding, with a direct transition between the increased refractive index core region and a decreased refractive index trench area in the cladding zone,

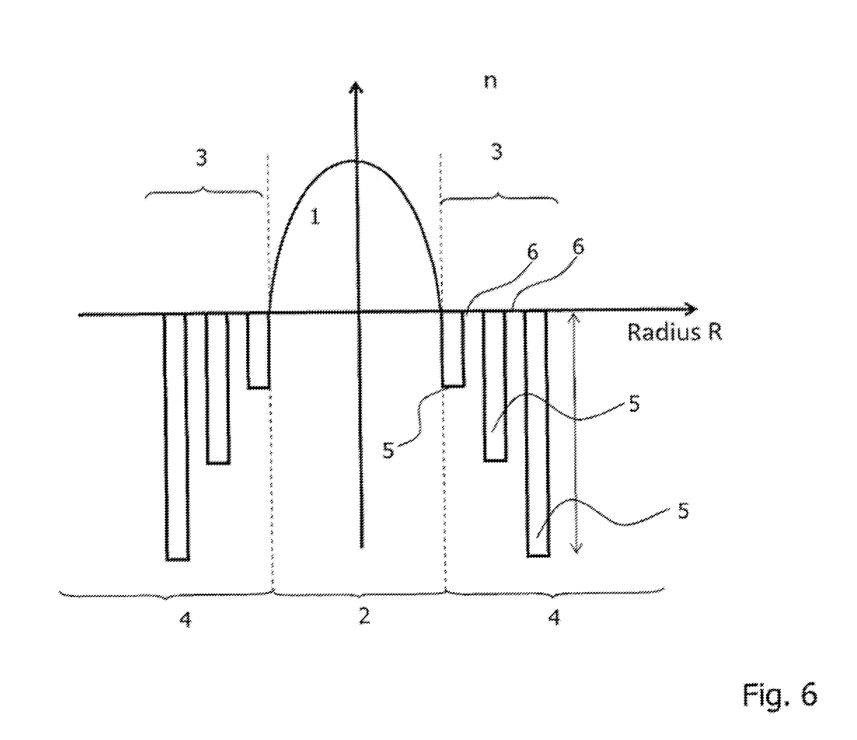

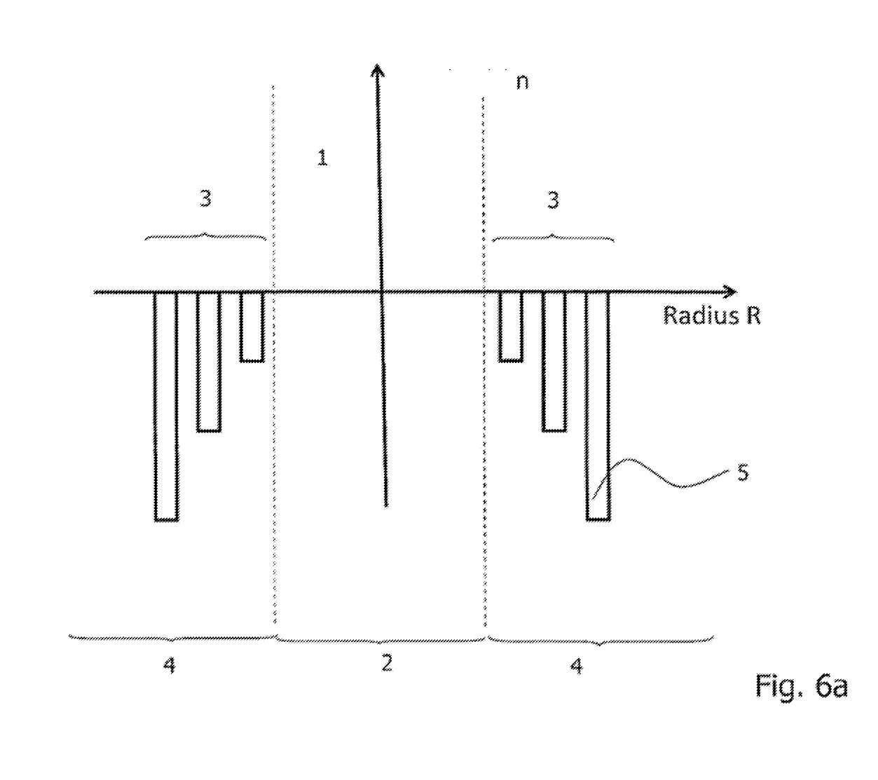

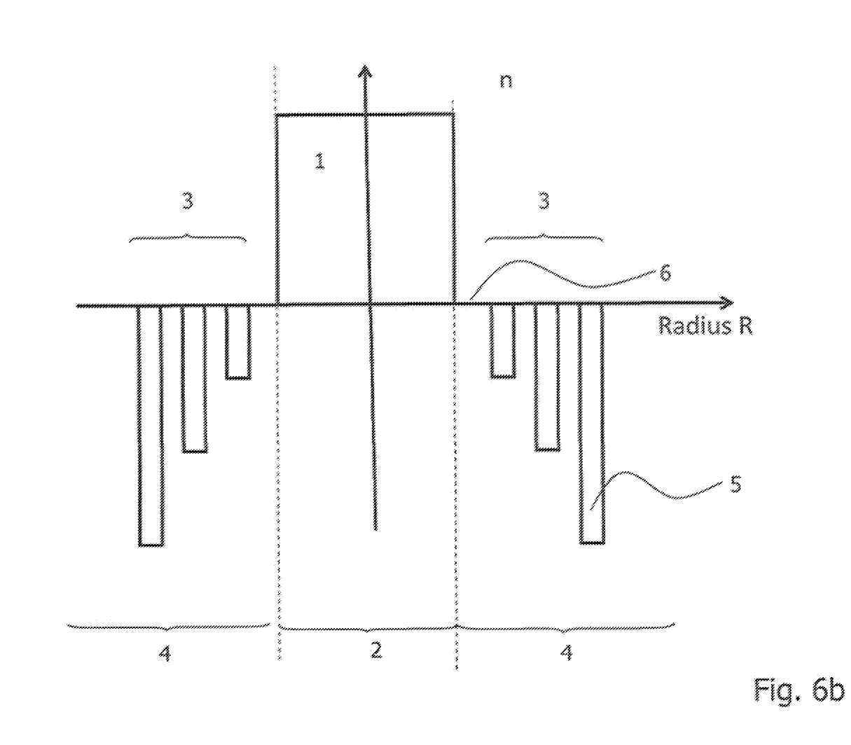

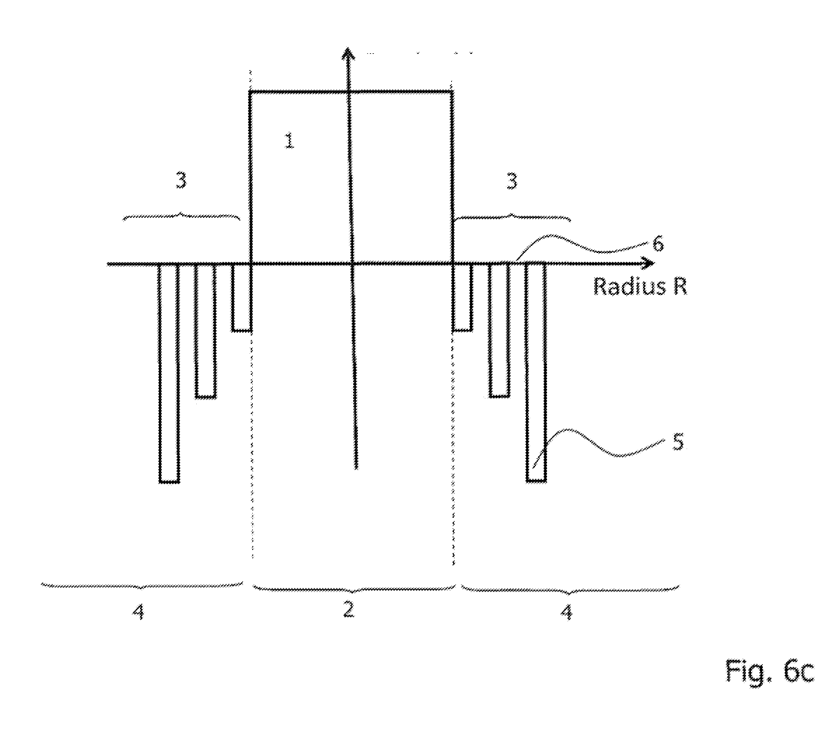

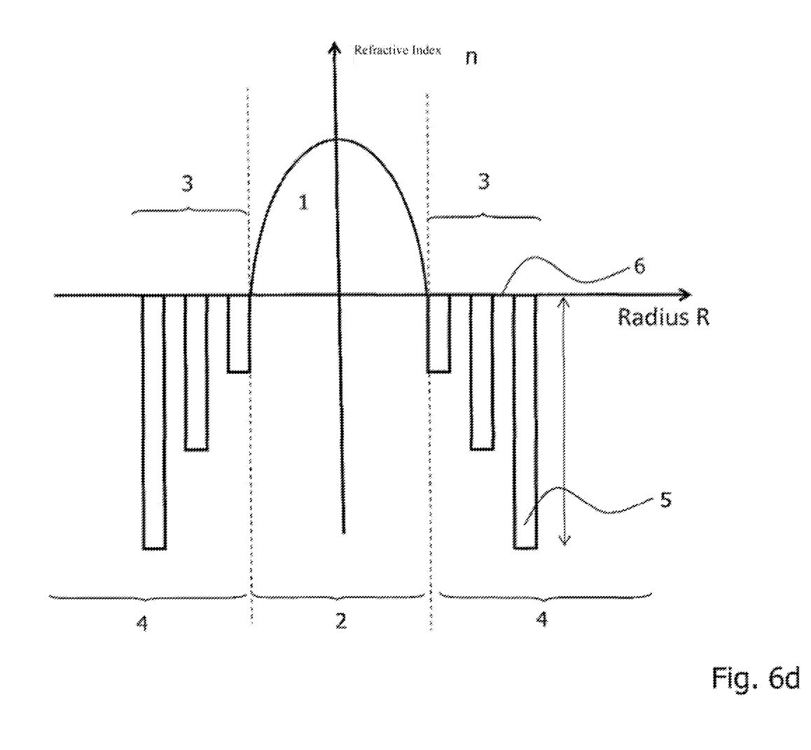

FIG. 6 shows a trench fine structuring with increasing trench depth within the cladding zone with a trench immediately adjacent to the core.

FIG. 6a shows a trench fine structuring with a core refractive index lying at the reference level,

FIG. 6b shows a trench fine structuring with a core refractive index lying above the reference level,

FIG. 6c shows a trench fine structuring with a constant core refractive index lying above the reference level without primary cladding,

FIG. 6d shows a trench fine structuring with a graded core refractive index lying above the reference level without primary cladding,

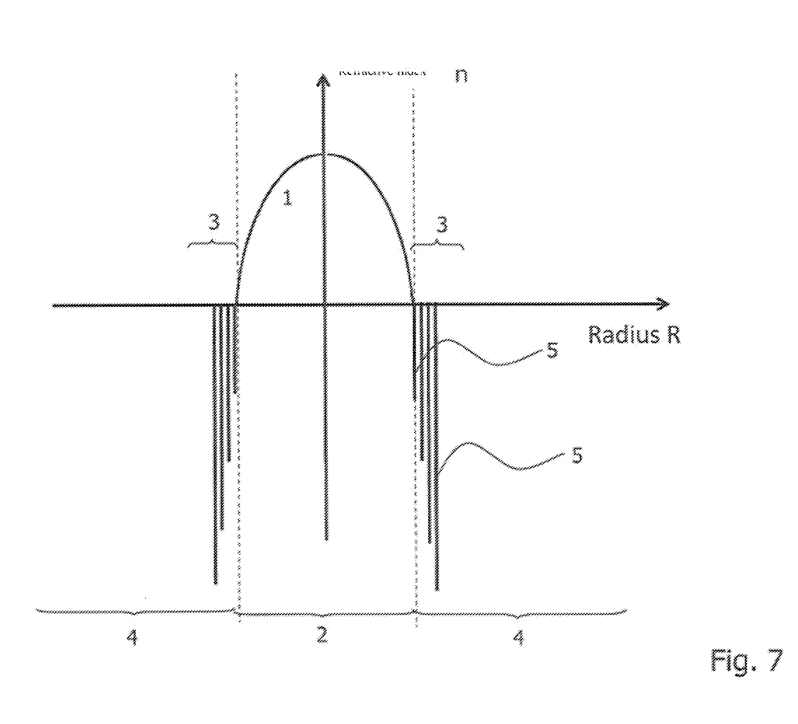

FIG. 7 shows a trench fine structuring with very thin trenches within the cladding zone.

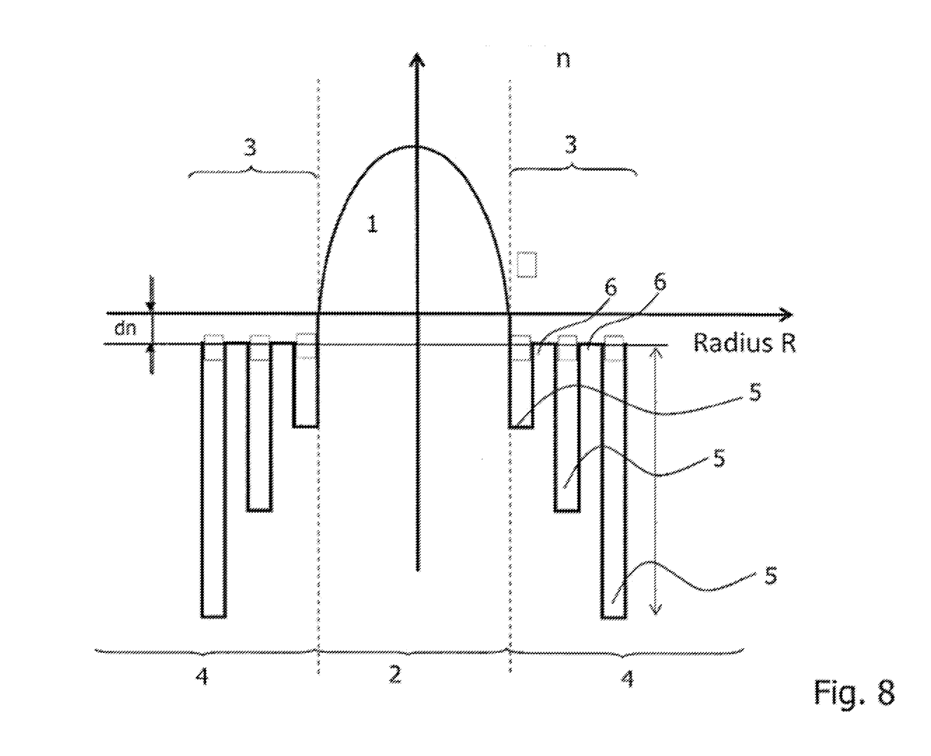

FIG. 8 shows a trench fine structuring with generally lowered refractive index level in the cladding zone, and a superimposed trench structure,

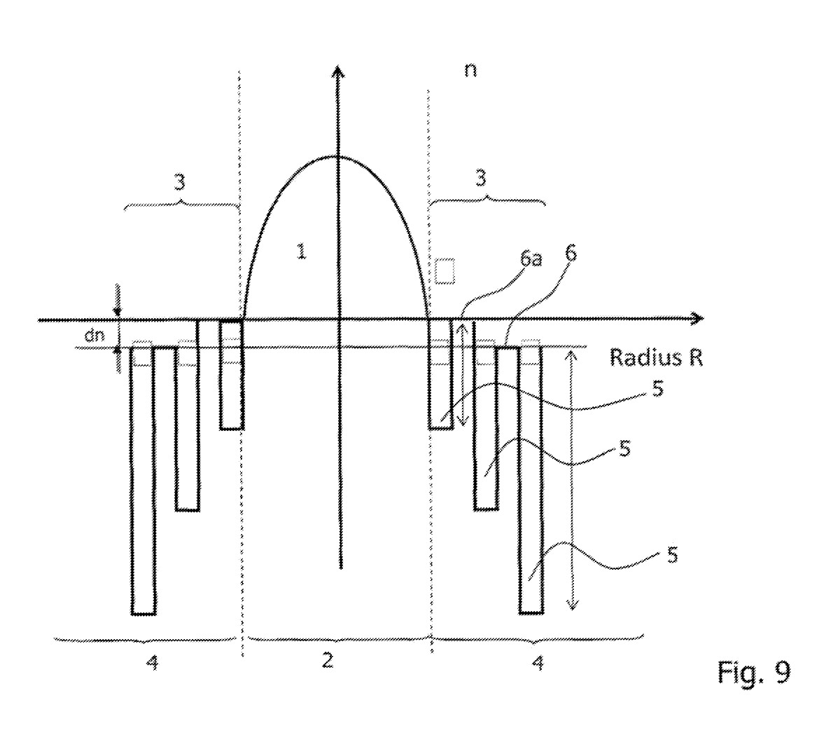

FIG. 9 shows a trench fine structuring according to FIG. 8, but with a sectional relative refractive index increase in the cladding zone,

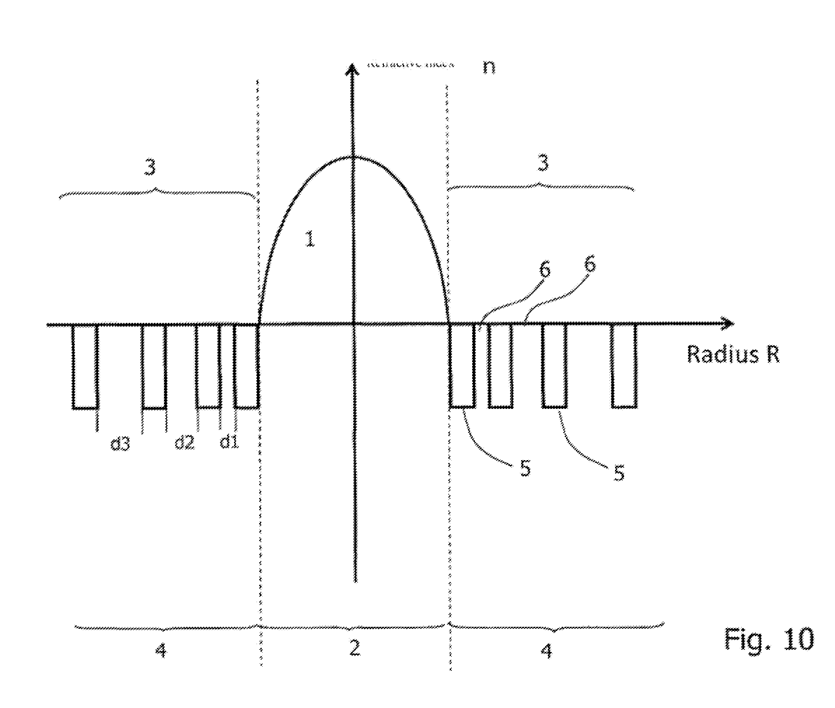

FIG. 10 shows a trench fine structuring with a graded structure in the core and trench structure in the cladding zone, in this case with an increasing trench distance,

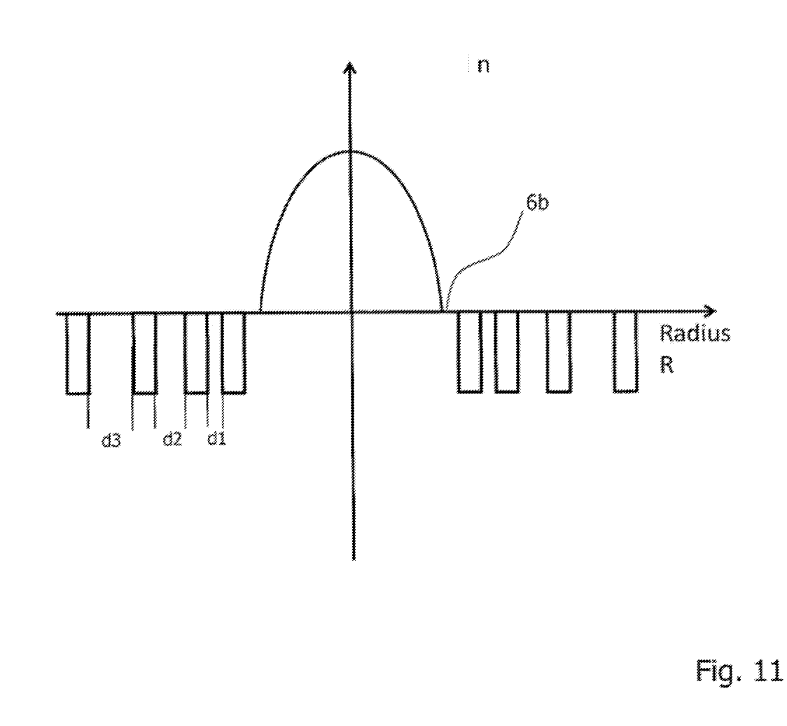

FIG. 11 shows a trench fine structuring according to FIG. 10, though here with a stepped refractive index curve between the core and the cladding zone,

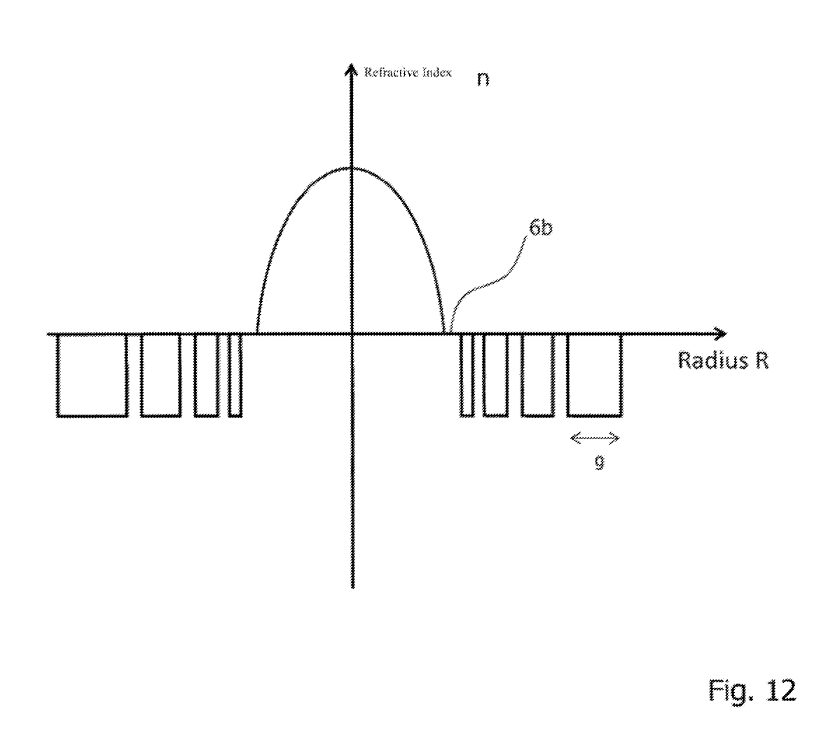

FIG. 12 shows a trench fine structuring with a graded refractive index in the core and a trench structure in the cladding zone, in this case with increasing trench width,

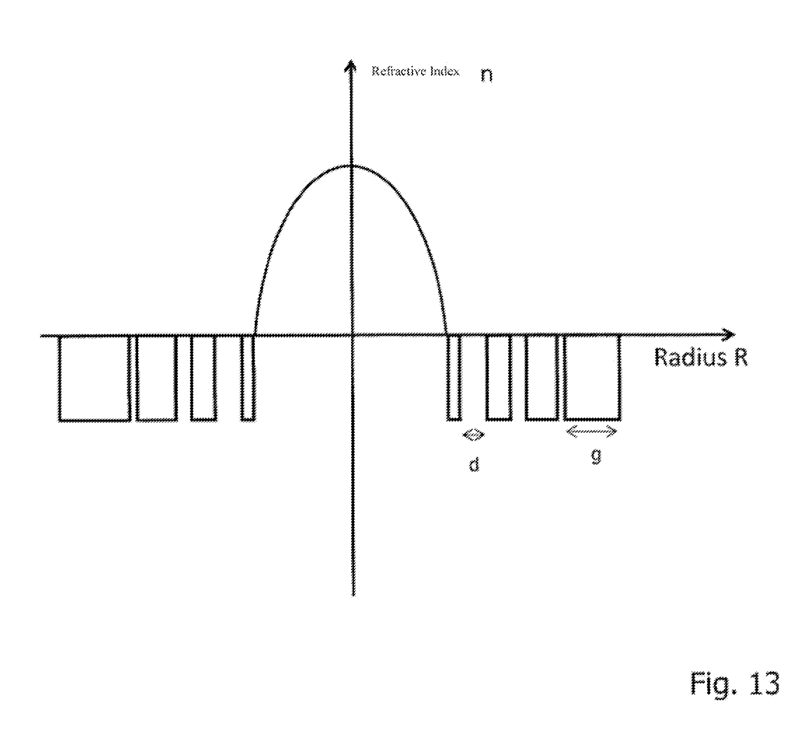

FIG. 13 shows a trench fine structuring according to FIG. 12, in this case with increasing trench widths in the presence of decreasing trench distances,

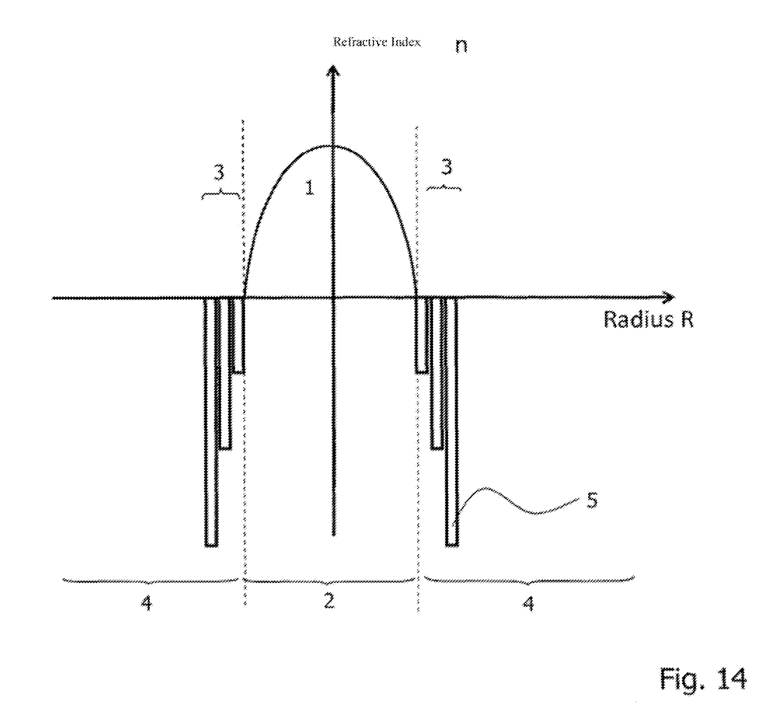

FIG. 14 shows a trench fine structuring with increasing trench depths in the case of closely and very closely spaced trenches,

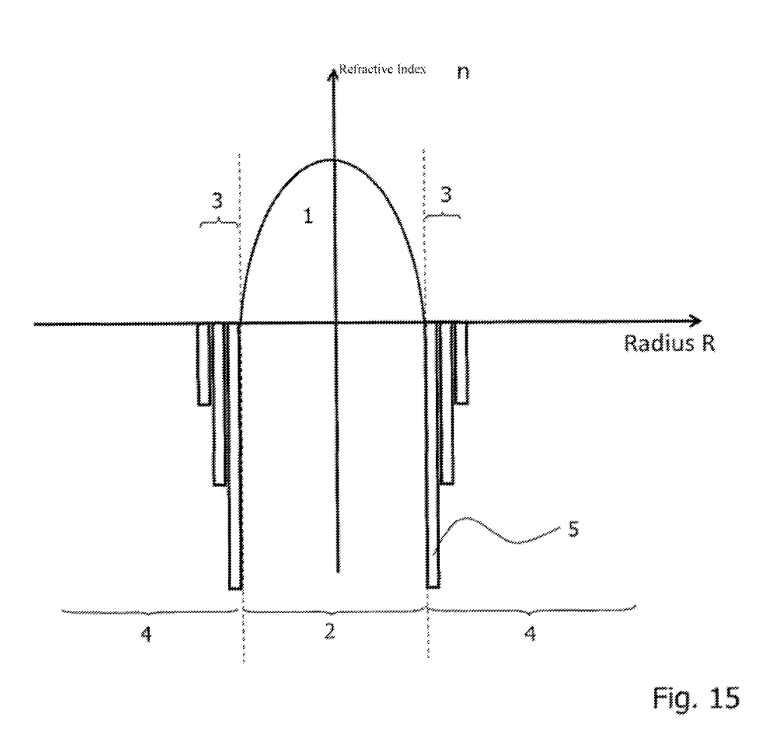

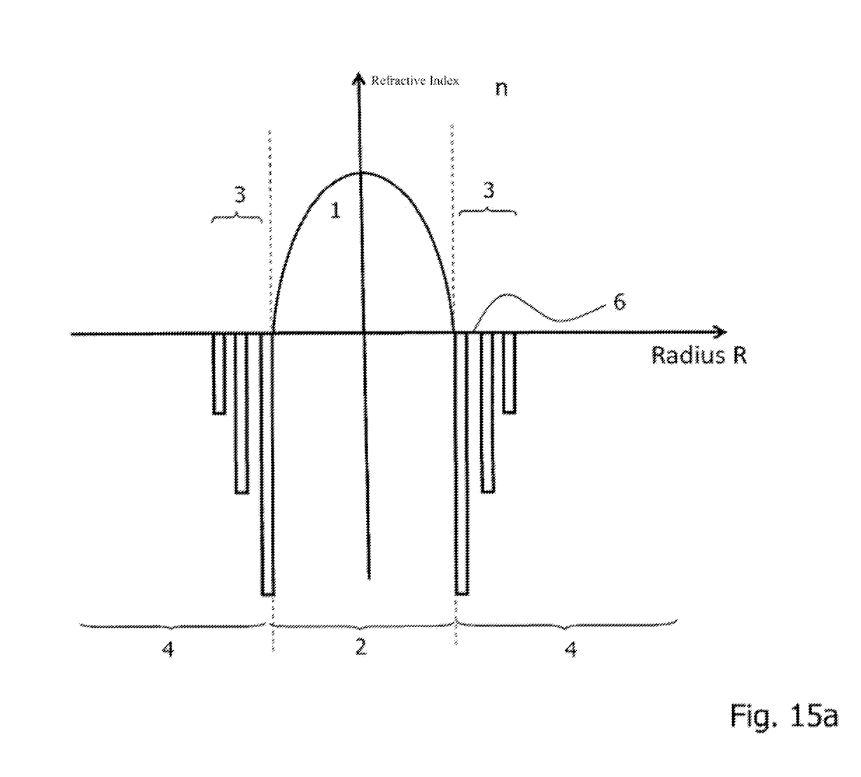

FIGS. 15 and FIG. 15a show a trench fine structuring according to FIG. 14, in this case with outwardly decreasing trench depth,

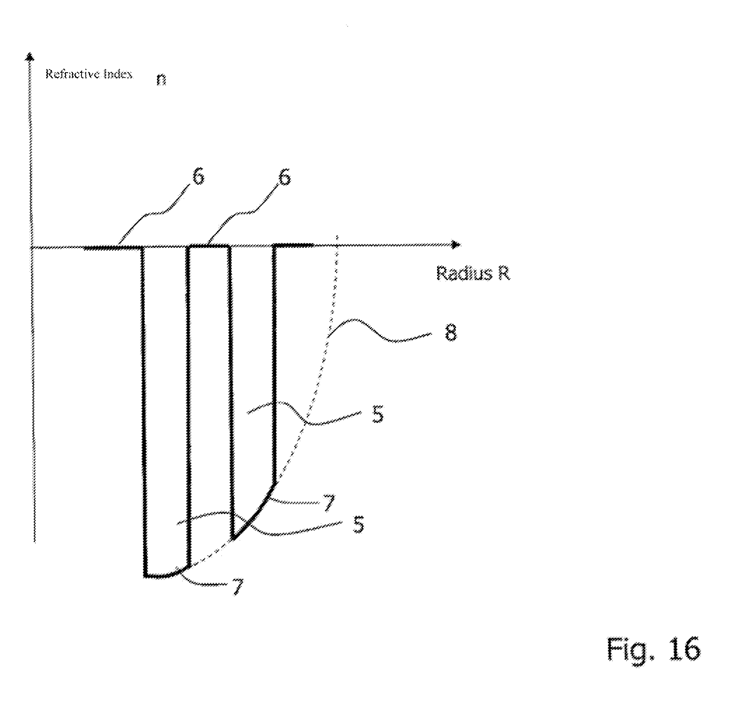

FIG. 16 shows a gradual structuring of the trenches in a first exemplary embodiment, with a definition of the enveloping and the grading curve,

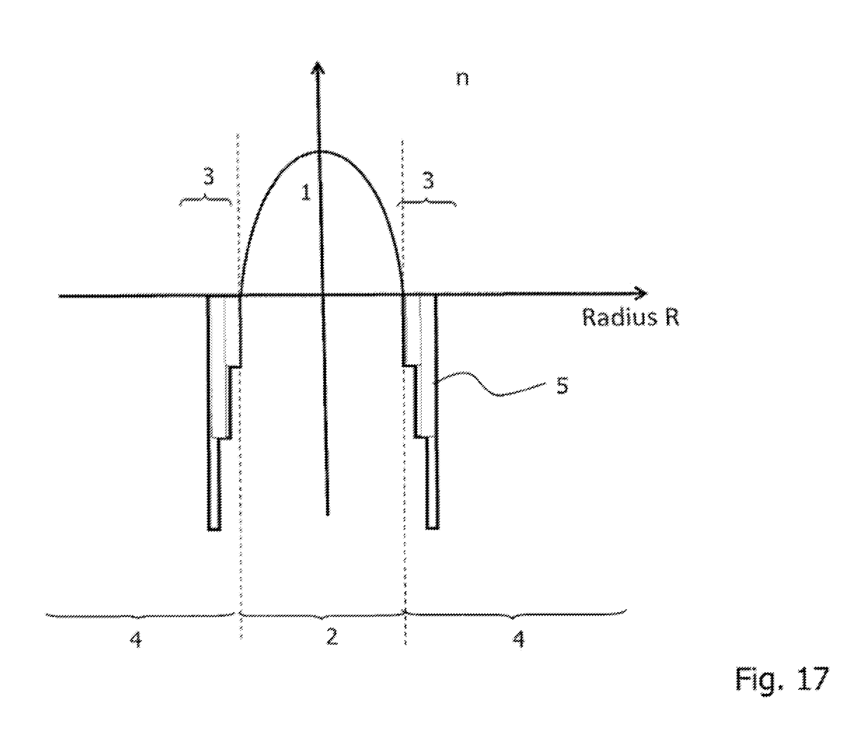

FIG. 17 shows an embodiment having a stepped grading of a trench,

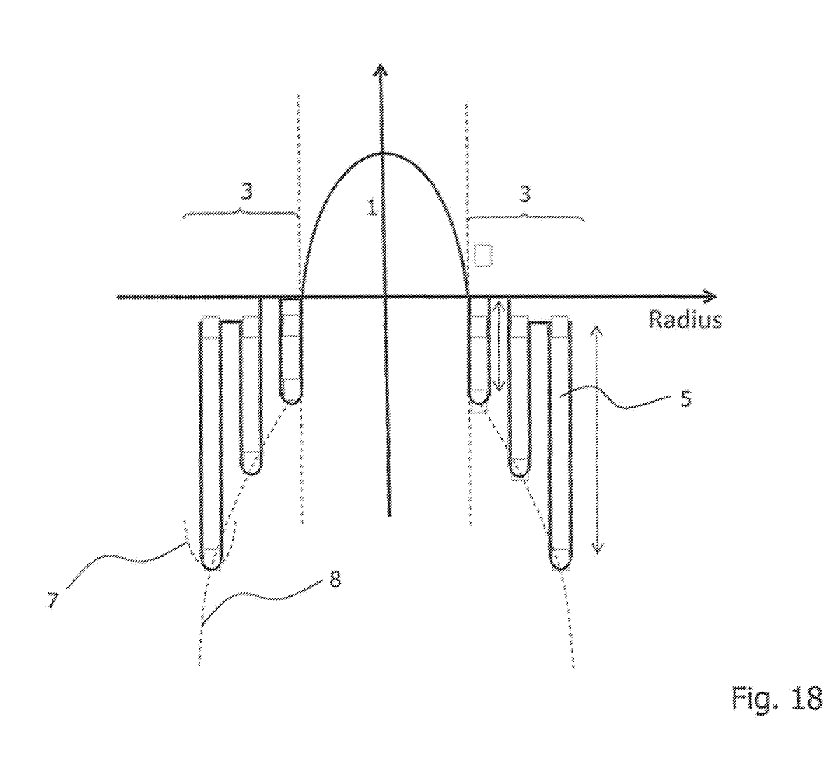

FIG. 18 shows an embodiment with a grading curve open at the top and an envelope curve open at the bottom,

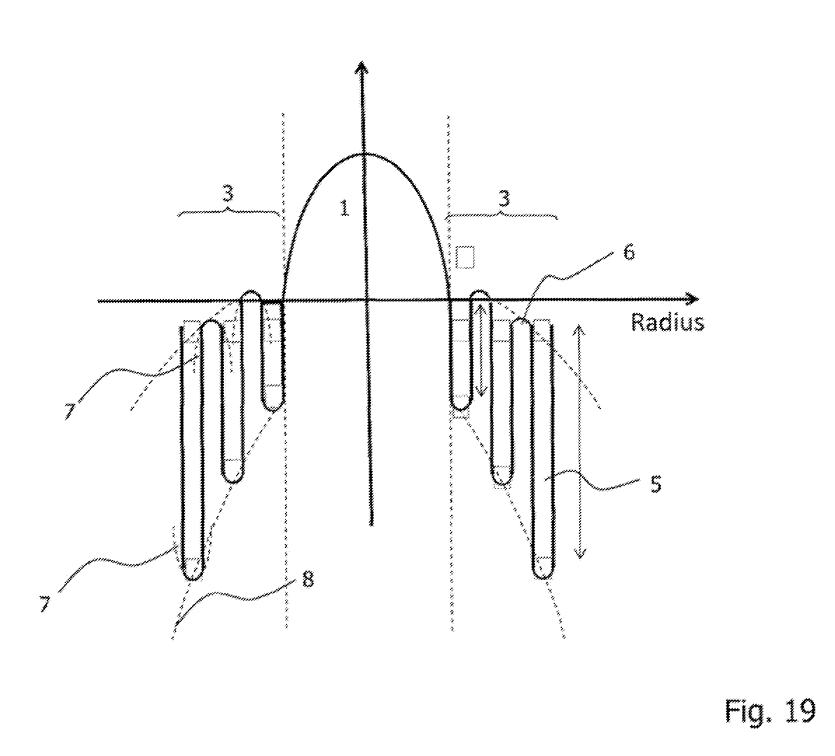

FIG. 19 shows an embodiment according to FIG. 18, baying in addition a grading of the secondary cladding,

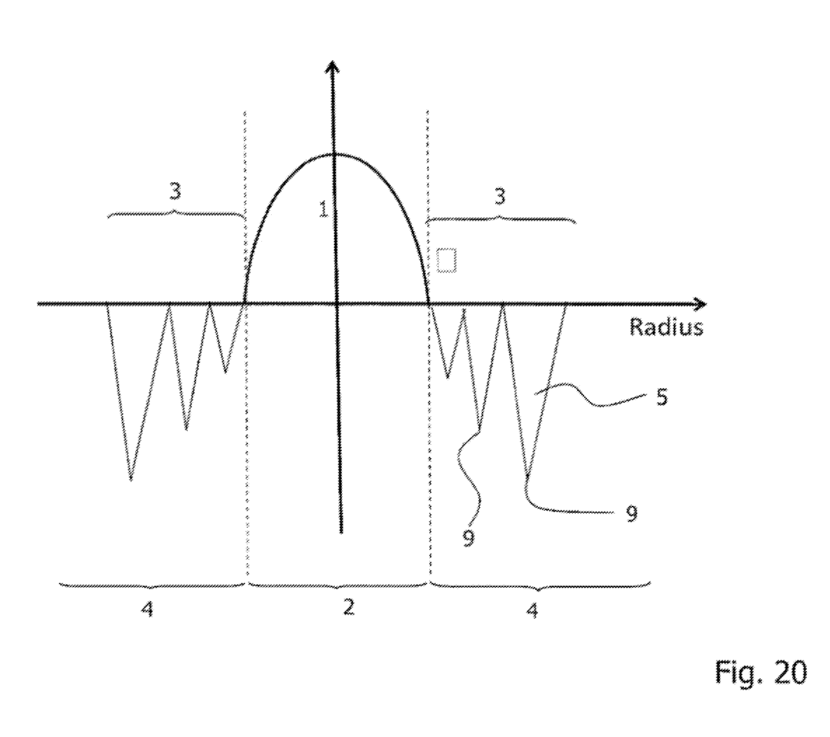

FIG. 20 shows an embodiment with trenches in the form of a symmetrical pointed profile,

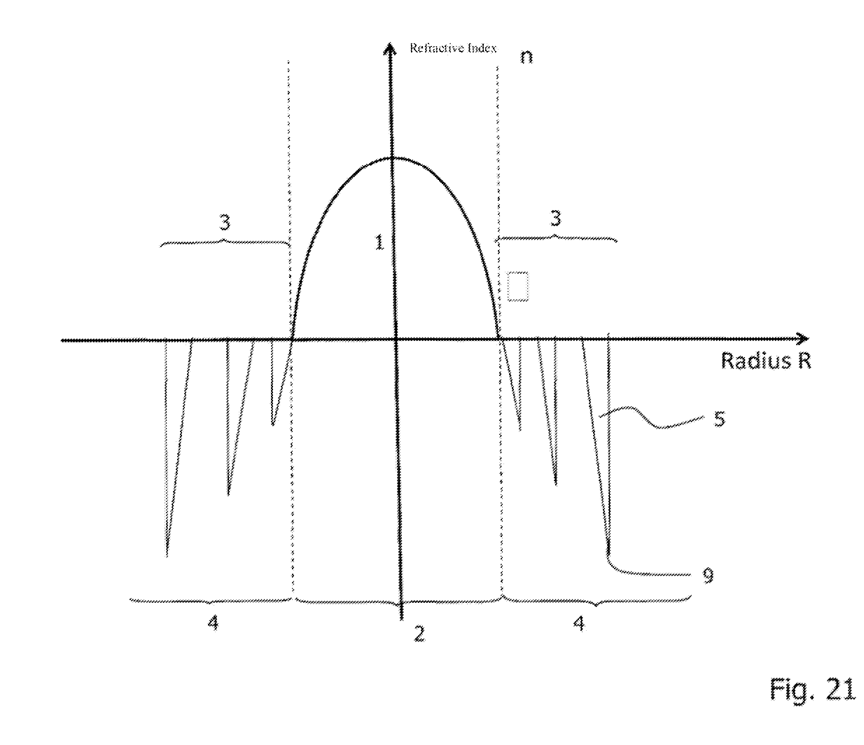

FIG. 21 shows an embodiment with trenches in the form of an asymmetric pointed profile,

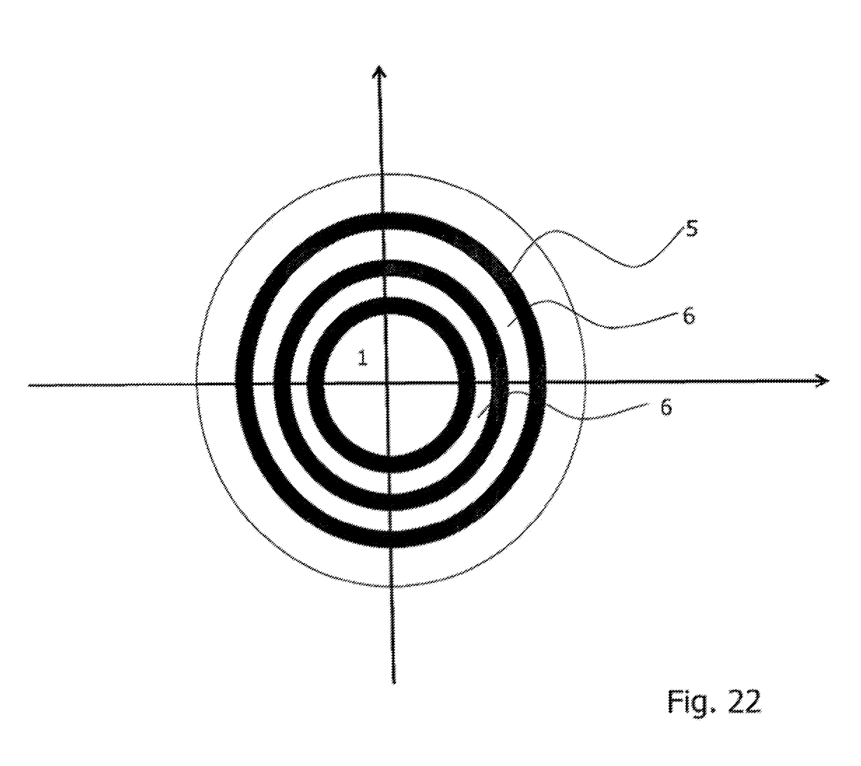

FIG. 22 shows an exemplary cross-sectional view of an optical waveguide with constant trench width,

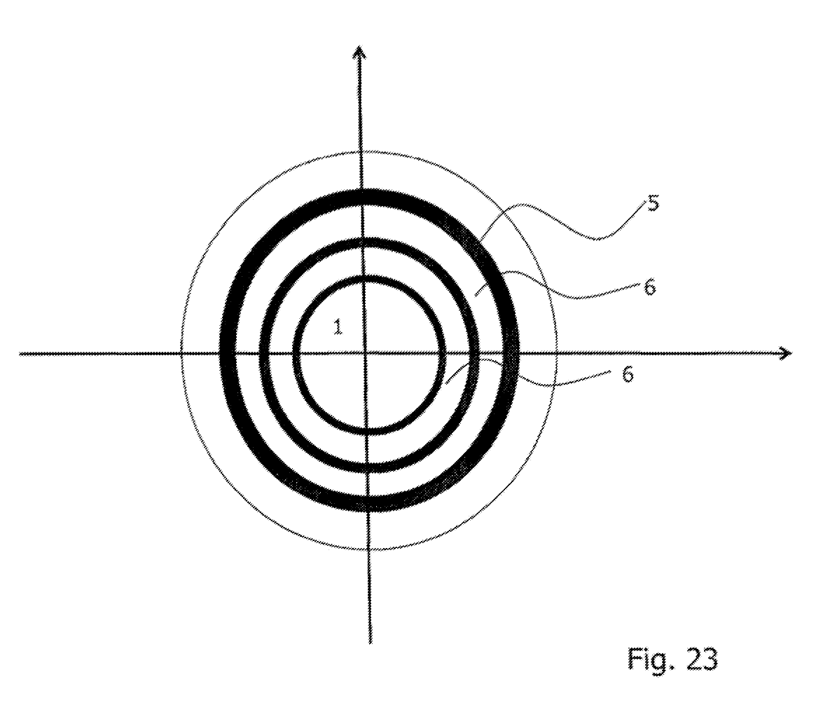

FIG. 23 shows an exemplary cross-sectional view of an optical fiber with an outwardly increasing trench width,

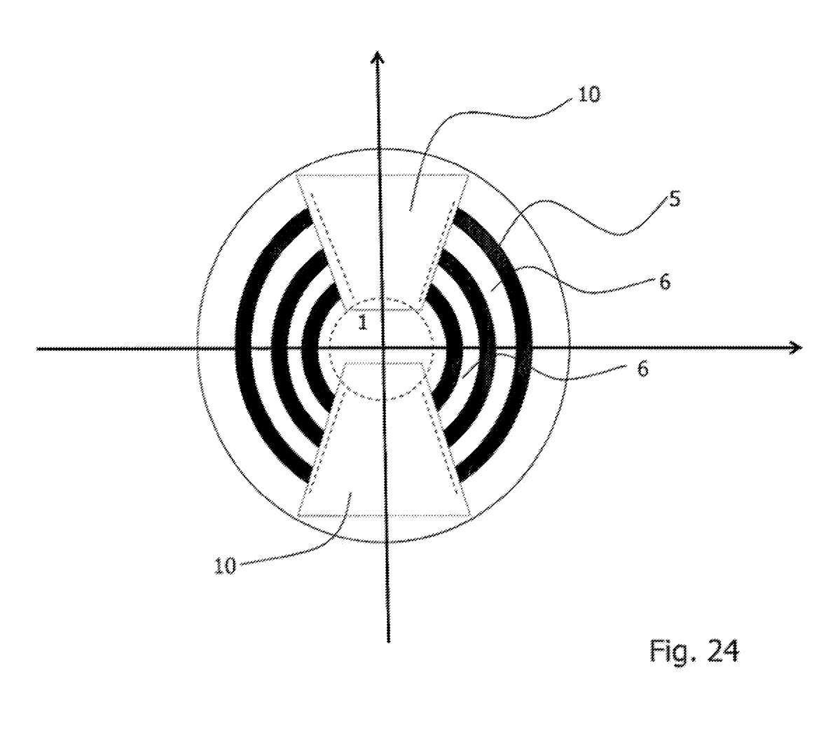

FIG. 24 shows an exemplary cross-sectional view through an optical waveguide with recessed trenches in a first embodiment,

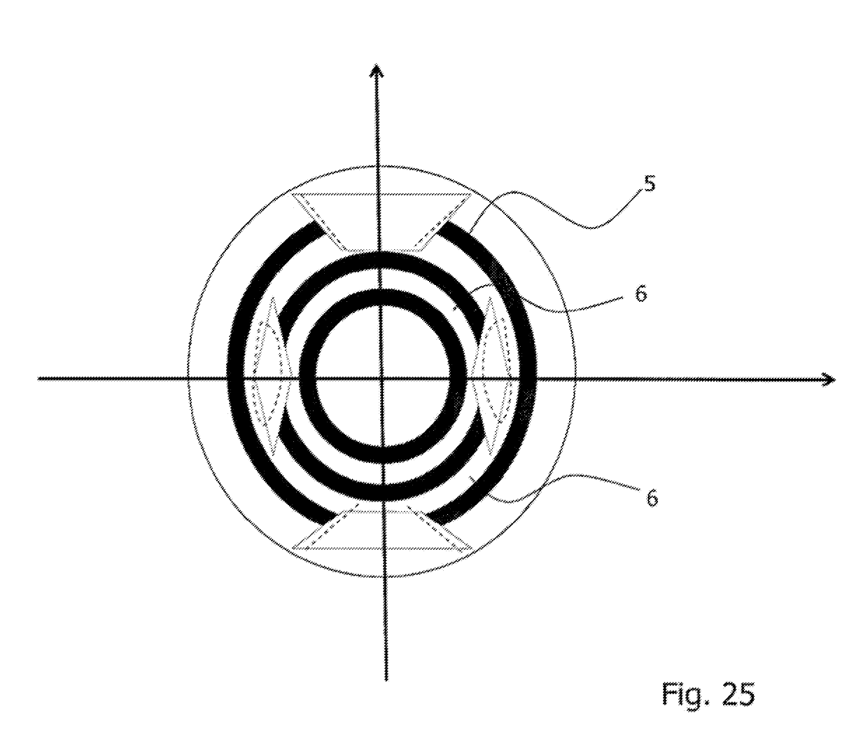

FIG. 25 shows an exemplary cross-sectional view through an optical waveguide with recessed trenches in a second embodiment,

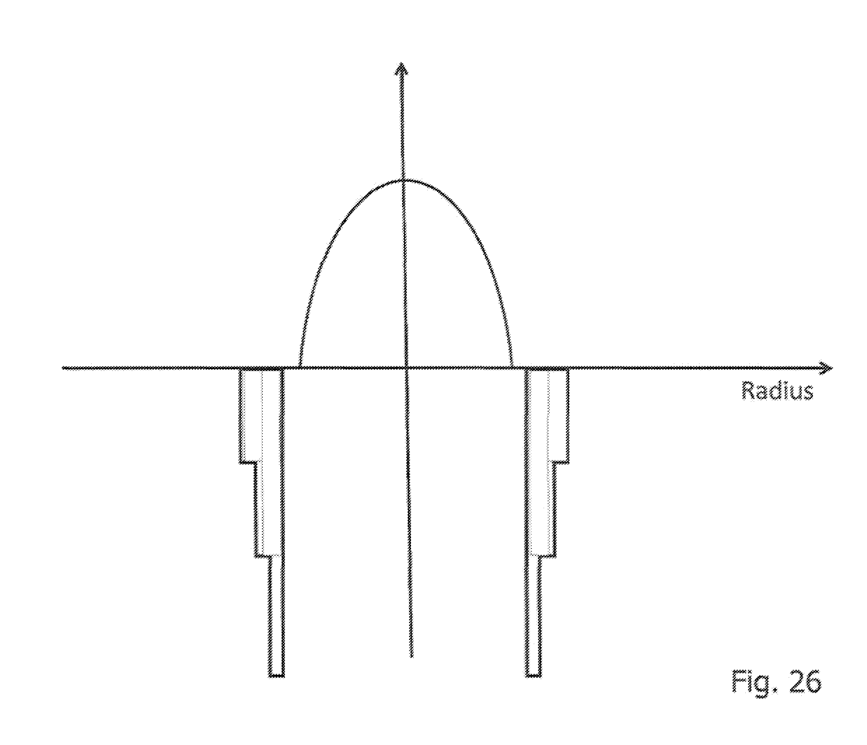

FIG. 26 shows an embodiment with successive trenches with decreasing refractive index at increasing radius,

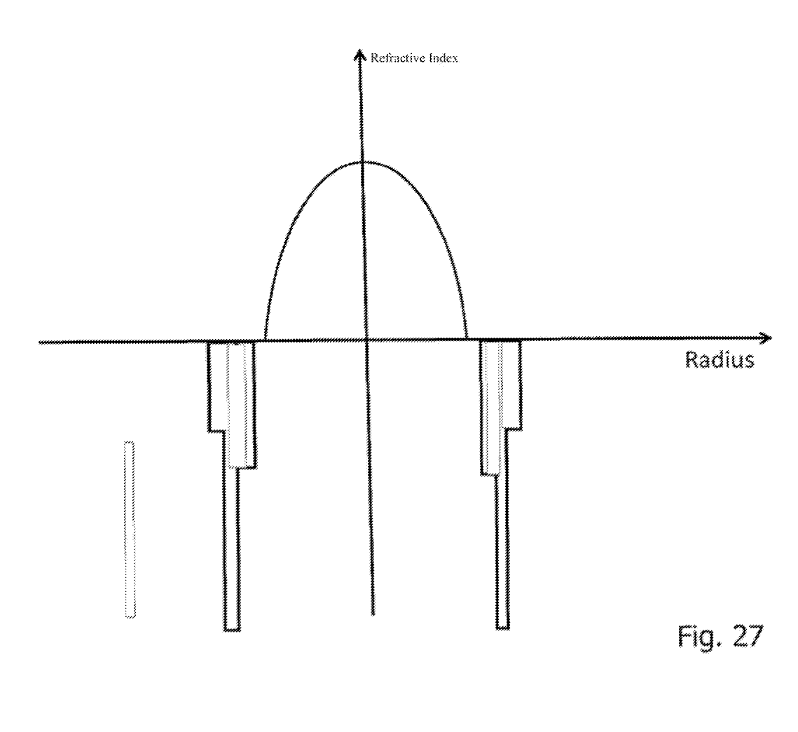

FIG. 27 shows an embodiment with successive trenches, wherein the trench with the maximum refractive index reduction is surrounded by two trenches having different but lower refractive index reductions,

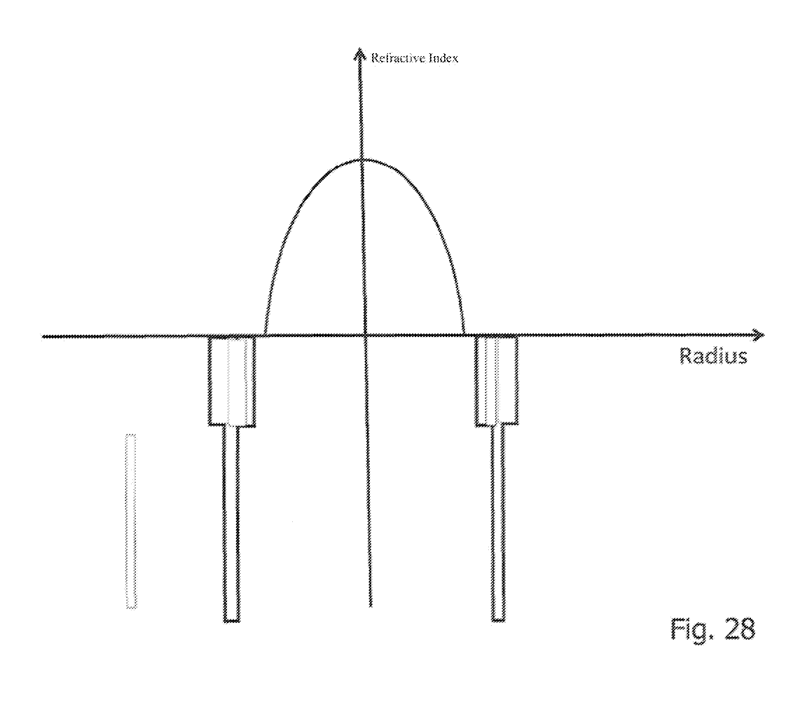

FIG. 28 shows an embodiment with successive trenches, wherein the trench with the maximum refractive index reduction is surrounded by two trenches having a lower refractive index reduction,

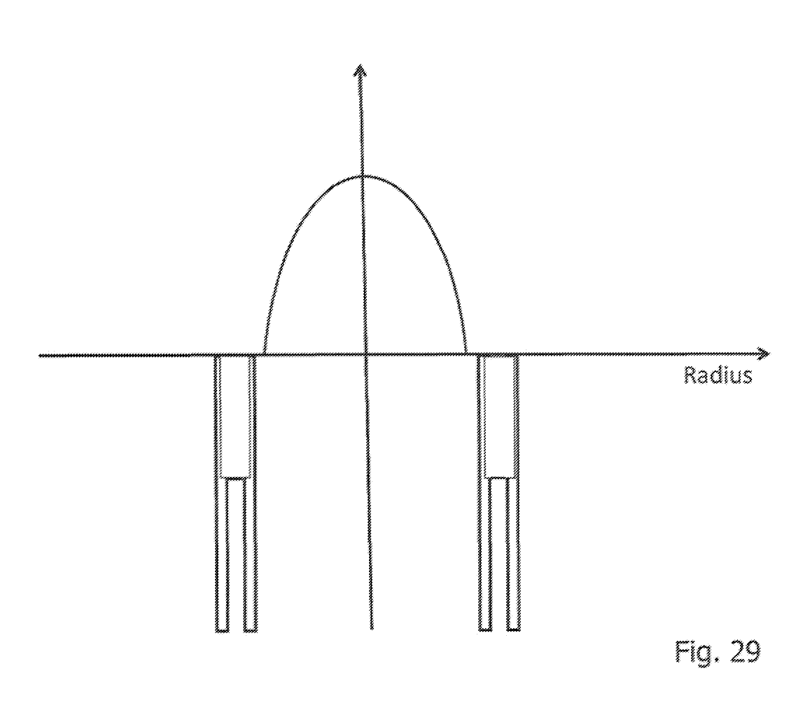

FIG. 29 shows an embodiment with trenches, wherein the trench having the minimum refractive index reduction is surrounded by two trenches having a higher refractive index reduction,

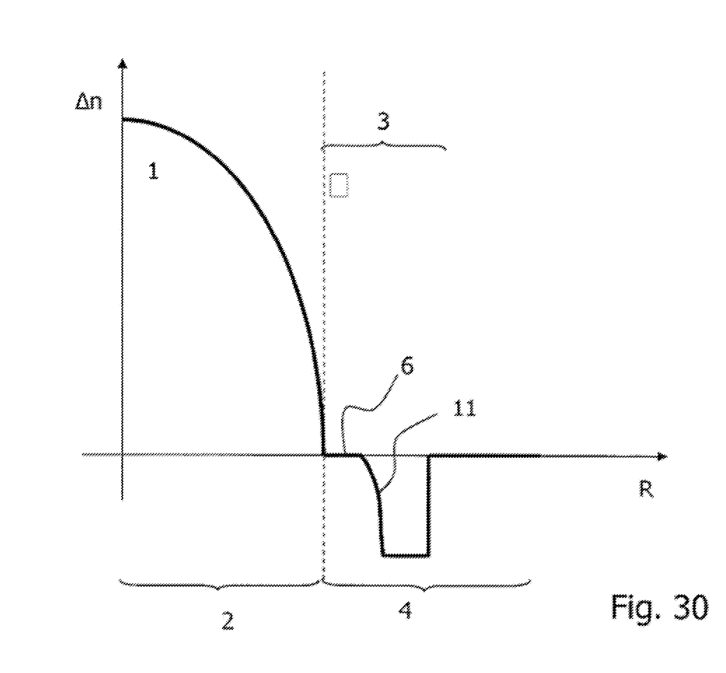

FIG. 30 shows an embodiment with a trench adjoining a graded core with a graded flank,

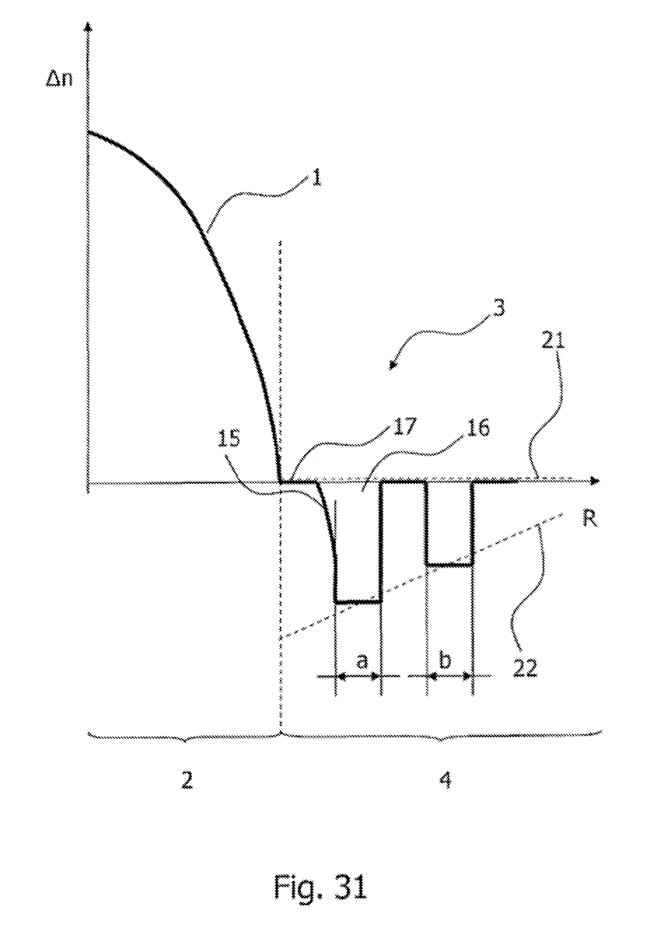

FIG. 31 shows an embodiment of a refractive index profile having a continuing, refractive index profile of the core zone and intermediate steps in the innermost trench,

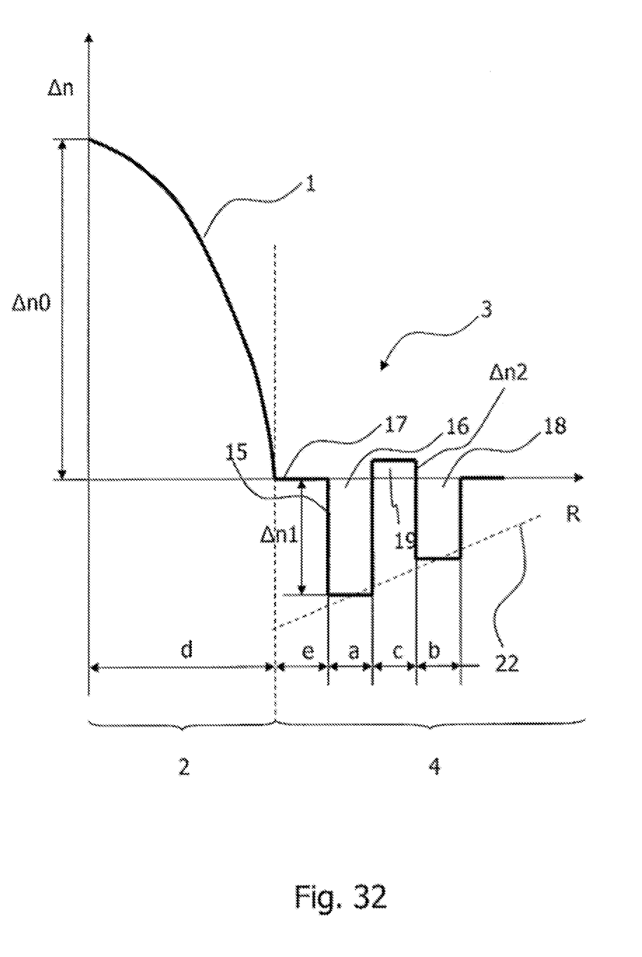

FIG. 32 shows an embodiment with two trenches and two intermediate steps,

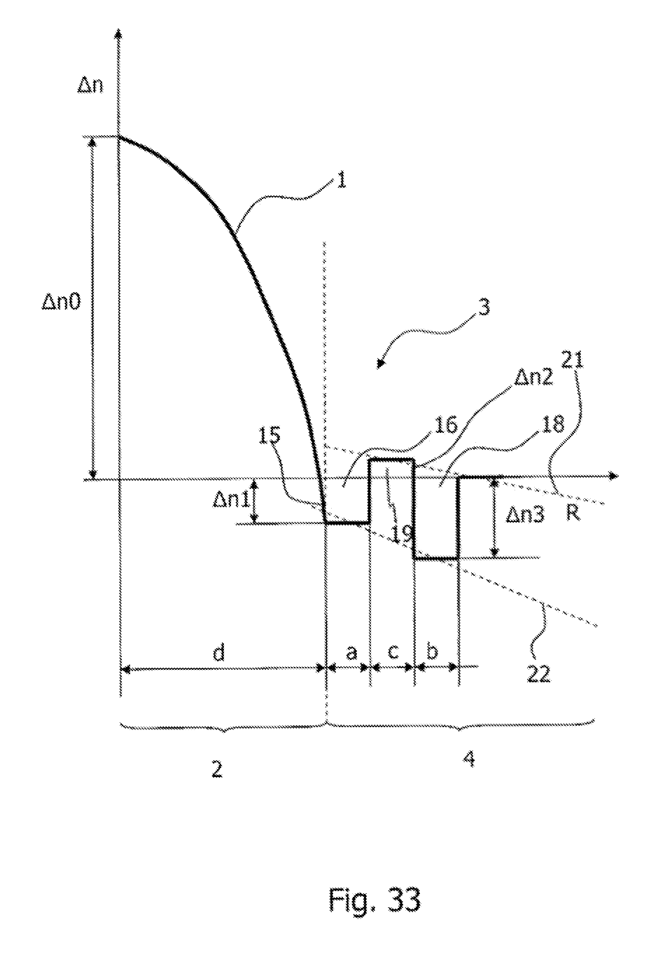

FIG. 33 shows an embodiment of a refractive index profile having a continuing refractive index profile of the core zone, two intermediate steps in the inner trench, and a second trench with a lower refractive index.

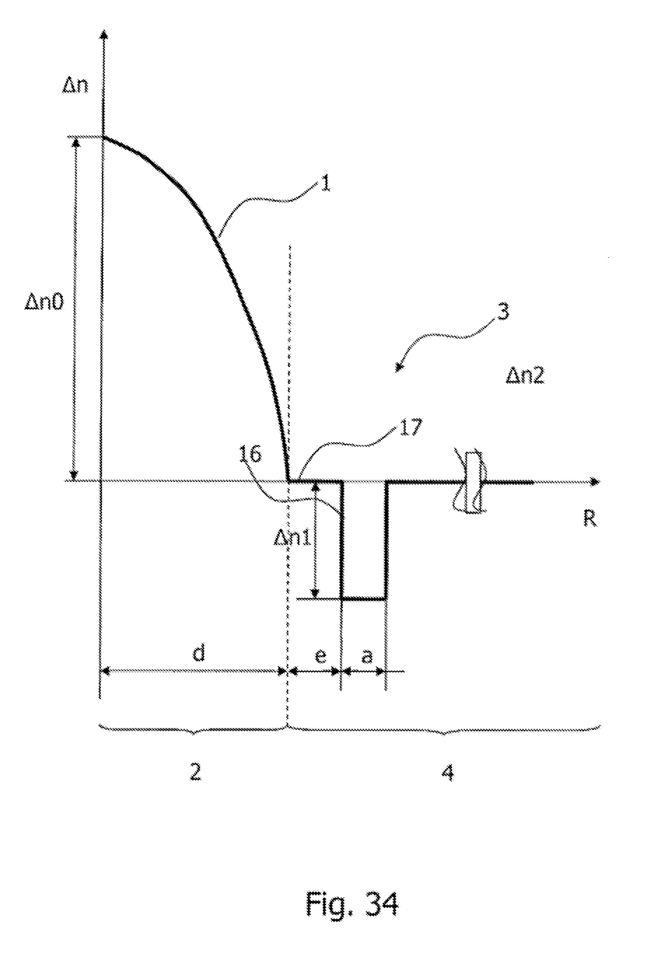

FIG. 34 shows an example of a section of a lamellar preform,

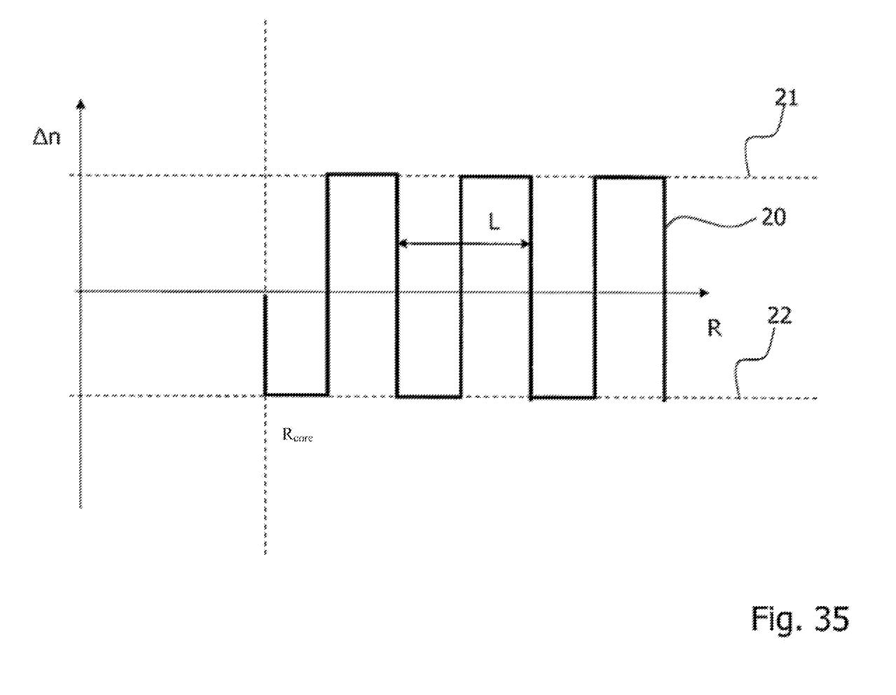

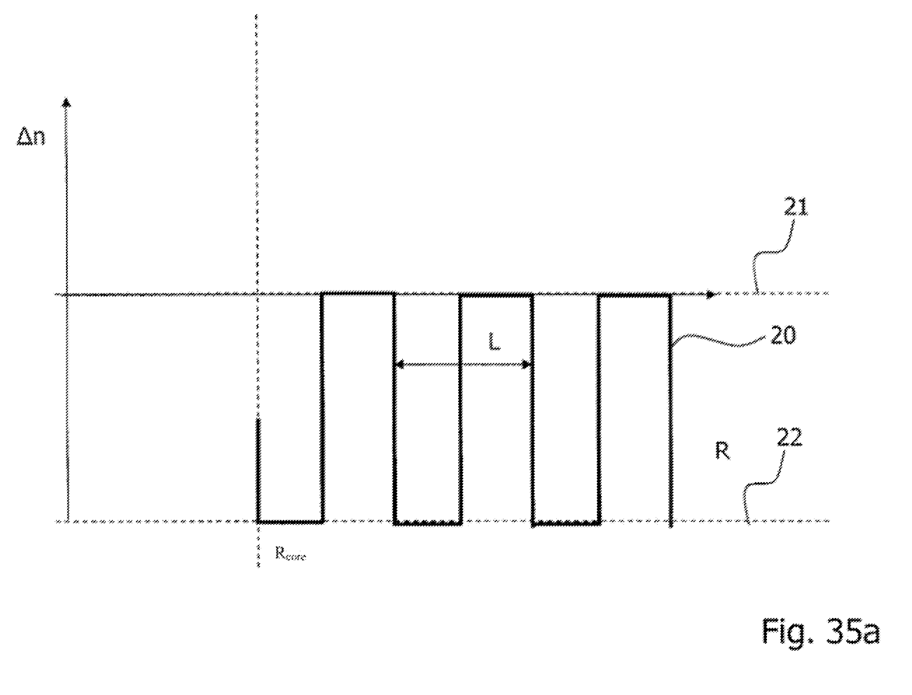

FIG. 35 shows an exemplary zone function having a rectangular shape with an upper and a lower envelope curve,

FIG. 35a shows a zone function shifted in a direction parallel to the ordinate.

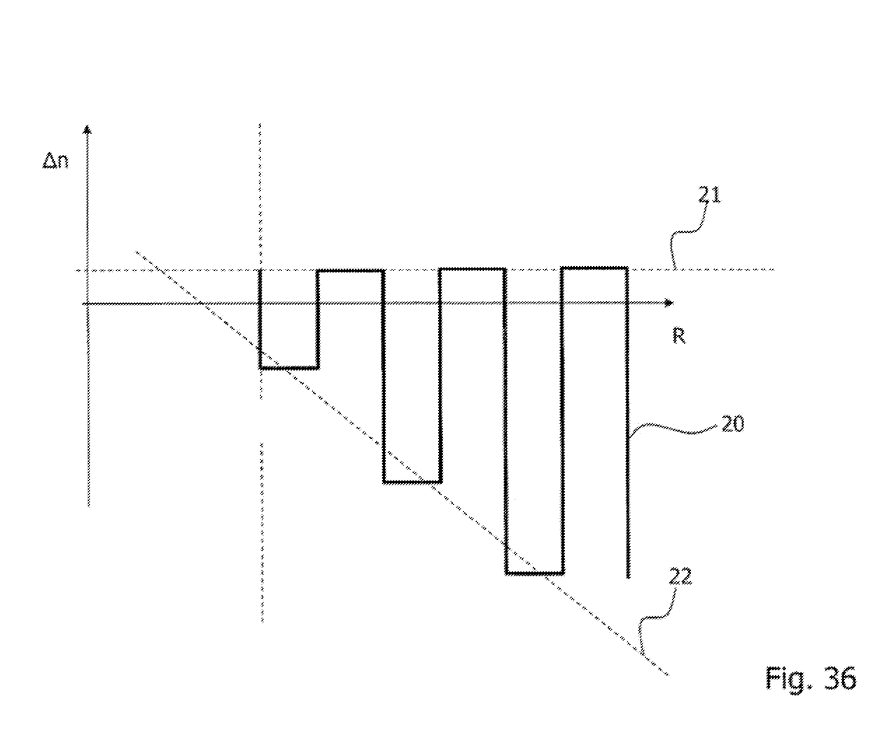

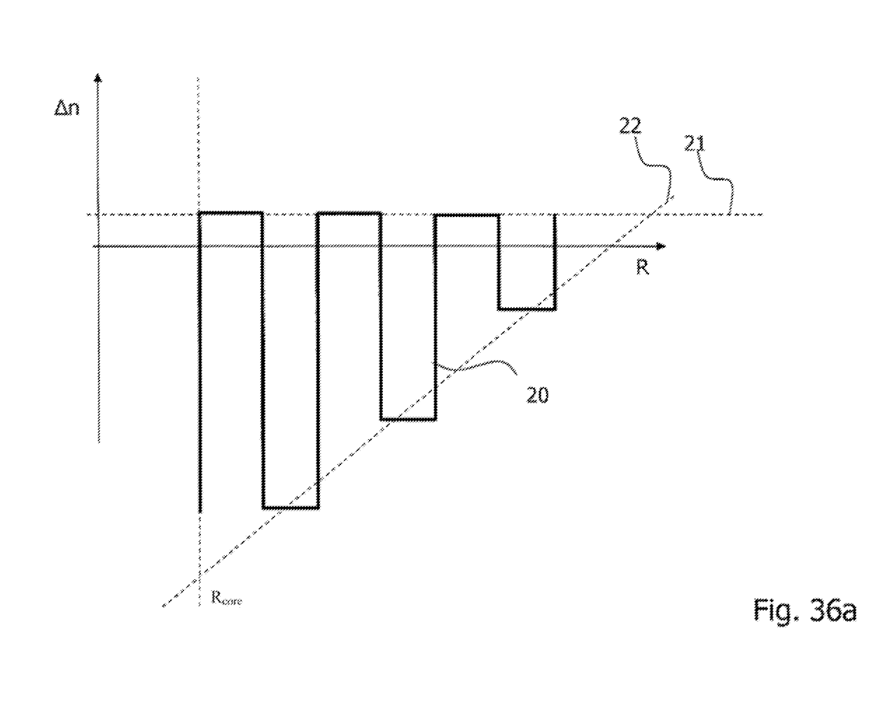

FIG. 36 shows a zone function having a rectangular shape with a constant upper and a graded decreasing lower envelope curve.

FIG. 36a shows a zone function having a rectangular shape with a constant upper and a graded increasing lower envelope,

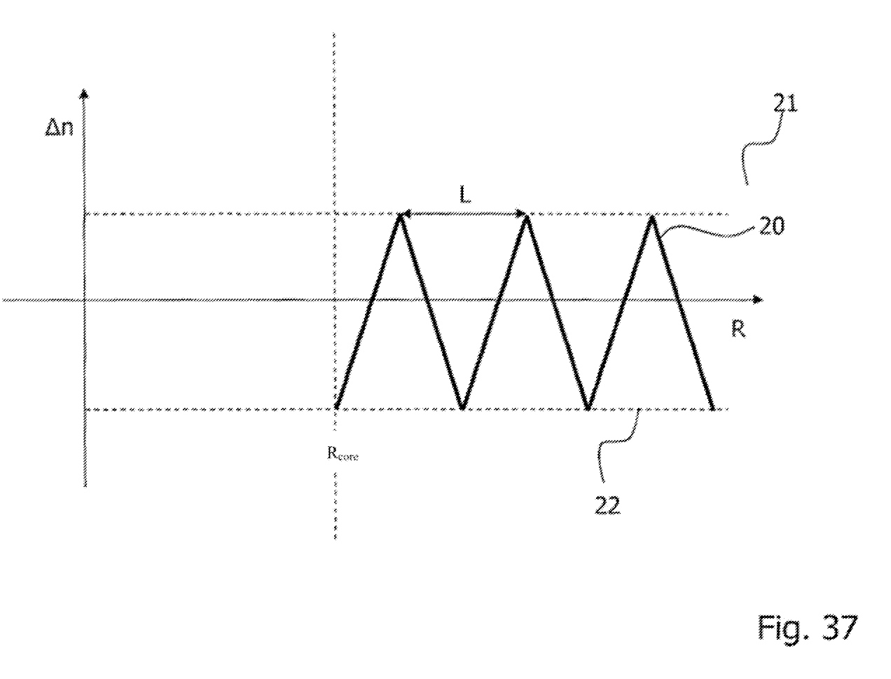

FIG. 37 shows a sawtooth zone function.

FIG. 1 shows in a diagram, and FIG. 1a shows by moans of an exemplary cross-section, a basic design of the structure of an optical waveguide. The diagram shows the curve of a refractive index n referenced to a standard value as a function of the radius R of the optical waveguide. The trench fine structuring basically consists of two areas. The first area is formed by a refractive index core profile 1. This area is located within a core 2 of the optical waveguide and only extends over the interface area between the core and cladding in the cladding zone. The second area of the trench fine structuring is formed by a refractive index trench profile 3, which is formed substantially concentrically around the core of the optical fiber. The refractive index trench profile is in the cladding zone 4 of the optical waveguide. While the gradient-like curve of the refractive index is smoothly formed in the core, i.e., first formed inside the nucleus without discontinuities, jumps and other breaks, the trench profile 3 is characterized primarily by a discontinuous curve represented by a succession of multiple trenches 5 with interposed lamellar steps 6. The areas delineated by the trenches may be narrow on the one hand in relation to the cross-section of the optical waveguide, while on the other hand they are characterized by a particularly substantially lower refractive index. The width of a trench, for example, is 1/10 of the cross-section of the optical waveguide or less. In this context, the most useful trench thicknesses are in the order of magnitude of the wavelength of the propagated light or the photons propagated within the optical waveguide.

The steps 6, however, are areas in which the refractive index is significantly increased compared to the refractive index in the trenches. The refractive index is therefore discontinuous in the refractive index trench profile. It jumps in particular in the deepest trenches between a lowest value n_{trench} and an average n_{cladding} at the steps 6 of the cladding zone. The difference between n_{trench} and n_{cladding zone} depends on the design and doping from about 0.001 to 0.5.

Through this design, a structuring is achieved that is particularly suitable for ugh transmission rates, e.g., laser transmission rates.

Bragg reflections can be obtained within the cladding zone by means of a particular design of the trench and the resulting structure in the cladding zone plates. This enables a selective wavelength interaction between the core and cladding region, in which only light components with selected wavelengths are reflected back into the core and are thereby guided within the optical waveguide. In fact, the optical waveguide in such a case acts as a filter.

For such applications, it is advantageous if the width of the fine structures is an integer fraction of the wavelength used later or a multiple thereof. Preferably, the layer structures should have a width of λ/2, λ/4 or a multiple thereof. Thus, it is possible also to influence the polarization of the light waves.

The base material of a filament-type optical waveguide is preferably quartz glass. Such optical fibers are generally made from a preform and take their final shape through the manufacturing step of fiber drawing. The preform is also referred to as a semi-finished product. In the majority of cases, the structuring that is present within the preform is retained when drawing the fiber. The refractive index profile within the fiber is thus now a scaled down and miniaturized representation of the refractive index profile in the preform at a much smaller fiber diameter. However, for the subsequent representations, it is therefore sufficient to describe the refractive index profile either of the preform or of just the optical fiber. The following examples, therefore, generally apply to both the preform as well as the finished optical waveguide, insofar as it is not indicated otherwise at specific points.

Using various selected refractive index profiles, the different designs should now be discussed, while the respective characteristics of the individual embodiments may be combined in any manner and extended by analogy. In principle it should be noted that any number of trenches may be provided. In any case, however, the trench fine structuring extends throughout the entire cladding zone. In this case, not only areas near the core, but also areas remote from the core, i.e., areas of the cladding region lying radially further outwards, are structured by the trenches.

The diagrams of the following figures show on the abscissa the radial distance R from the center of the core R=0 in arbitrary units. The representation is not limited to optical waveguides with a circular cross section, but can be applied in a similar manner to optical waveguides with an arbitrary cross-sectional shape. For other optical waveguides such as the additional planar waveguide with a rectangular cross-section shown in FIG. 1a, the R abscissa denotes a distance along a line drawn through the cross-section, especially a diagonal, a semi-axis or an axis of symmetry.

On the ordinate of the respective diagrams, the normalized refractive index n is plotted in the form of a difference in refractive index for each reference material used. The reference material is preferably the matrix material of the optical waveguide. Usually, pure quartz glass is used as the reference material for optical waveguides. The reference material is subsequently assigned the arbitrary value of 0 in the refractive index measurement, since the light-guiding properties of the fiber depends above all on refractive index differences between the fiber sections.

In the case of some operating conditions, in particular for optical transmission over short distances, optical waveguides made of glass as well as of plastic can be used. The reference level must be correspondingly adjusted in such a case to the level of the base plastic used. In the case of plastic optical waveguides, the optical waveguide uses, for example, several plastics with different refractive indices in the core and in the cladding zone. The following diagrams and descriptions also apply to plastic waveguides on normalization of the refractive index of the base plastic to the value n=0. For the sake of a convenient presentation, the explanations given here refer exclusively to optical waveguides based on a quartz glass matrix.

Positive ordinate values and thus refractive index increases in comparison to the reference value of the reference material are produced by using material with a higher refractive index compared to the base material. The refractive index increase is usually achieved by at least doping the matrix material with corresponding chemical compounds. Negative ordinate values are obtained in a similar manner, whereby material having a low refractive index compared to the reference level is applied. The lowered refractive index is also usually achieved by at least one doping of the matrix with corresponding chemical compounds.

When using quartz glass as the base matrix, conventional dopants such as fluorine, germanium, boron, aluminum, phosphorus, titanium or active ions such as ytterbium, cerium, holmium, and other materials are used. In particular, compounds of metals and semi-metals containing Ag, Au, Cu, Ni, Ta, Zr, Sn, Zn, Hg, Ru, Rh, Ir, Os, Ro, W, Ti, Al, In, Ga, Nb, La, Sm, Ce, B, P, Sr, Ba, Mo, Cr, Fe, Co, Se, Mn, Ge, V, In, Bi, Pt, Pd, Tc, V, Pb, N are used. The choice of dopant is not limited to the compounds and elements listed here, but can be performed with any element of the main and sub-groups, as well as rare earth elements, insofar as they, or their combinations, achieve the desired refractive index change.

Usually only two or three trench structures are exemplified in the embodiments. They serve only as an illustration of the principle behind it and can be arbitrarily increased in number and design. A higher number of the trenches improves the optical properties of the optical waveguide. In particular, the quality of the above-mentioned Bragg reflections increases with the number of the trenches.

The maximum number of successive trenches lowering the refractive index may be formed depending on their radial distance from the center of the optical waveguide. This dependence can be designed to be linear or non-linear. In the latter case, the trenches can form, in particular, it structure having a parabolic-shaped envelope curve, whose shape (slope, aperture angle, compression/extension) is adjusted depending. on the intended application of the fiber and/or on the core design.

The trenches themselves can have a rectangular refractive index profile. In this case, the refractive index at the interfaces of the trench jumps to adjacent layers, whereby the refractive index over the entire trench width has a constant value. The refractive index profile of the trenches can also be formed to be gradual. In this case, the refractive index profile of the trench differs from the rectangular shape. In this case, the refractive index is then much lower across the trench width than in the surrounding area, but is no longer constant. Both cases are presented in more detail below.

The following embodiments and values relate to an optical waveguide based on quartz glass. The data can be transferred by corresponding conversion algorithms to a preform, or also to other glass materials and plastics

Combined methods can be used to produce the refractive index profiles described below in the case of quartz glass-based optical waveguides. In particular, outer coating processes, such as the known plasma and/or flame-based outer coating processes, can be used, combined with methods for internal deposition such as the known CVD method and jacketing and/or collapsing method. Examples of implementation are given in the individual embodiments, whereby the production thereof is riot strictly bound to the aforementioned sequences, but can be modified or extended by persons skilled in the art in a suitable manner through additional process steps.

Subsequently, the first refractive index area occurring in an outwards direction from the center of the fiber or located at the center of the fiber is referred to as the fiber core, or simply as the core. The cladding zone refers to the area surrounding the fiber core. In optical waveguides and their preforms, the term cladding is used. The terms “cladding zone” and “cladding” are hereinafter used interchangeably.

The geometry of the core and the cladding zone as well as the various areas having the same refractive index, is preferably circular, Each area may have a different form, however, independent of the circular symmetry. In particular, polygonal shapes and/or oval cross-sections are used. In this way and depending on the application, efficient mode mixing can be achieved in the optical waveguide.

The usual core diameter of the optical fiber is in the range of 5-400 μm, preferably between 50-150 μm and more preferably between 50 and 62.5 μm.

FIG. 1a shows a refractive index profile of a typical first embodiment. The figure shows an optical waveguide having a gradually positive refractive index profile 1 in a core 2. The refractive index decreases parabolically from a maximum value at the center of the core over the radius R to a core-cladding interface indicated here with a dotted line. Thus in the core, there is as typical gradient of the refractive index, while the shape of the refractive index gradient can be adjusted by a person skilled in the art for the respective application by doping the core accordingly.

The exact curve of the refractive index gradient depending on the radius in the core can be selected in various ways and described, by functions of the radius. It is appropriate here to fall back on power functions of the following type, while the parameters a and a can be assigned different values depending on the application, and that are valid for a special preform or a special optical waveguide.

$$Δ n ( R ) = Δ {n}_{max} \cdot ( 1 - {( \frac{R}{a} )}^{α} )$$

Δnₘₐₓ describes the maximum refractive index difference where R=0, i.e., at the center of the fiber, while a is the radius of the fiber core.

Δn area of a first step 6, which is variable in width, is adjacent to the core, and has the refractive index of the reference material. The trench structure 3 borders and closes of this area. This is located within the cladding zone 4. The trench structure consists of an alternating, series of trenches 5 with a decreased refractive index and step 6 that has the refractive index of the glass matrix of the cladding zone.

A trench 5 has an area that is variable in its width, and a lowered refractive index area in comparison to the reference base. In the embodiment shown in FIG. 1a, the trench 5 adjoins in its turn an area of step 6 with the reference refractive index that is variable in width.

The area of the steps is divided below into primary cladding and secondary cladding. The term primary cladding refers to the area that is located in direct contact with the core zone. On the other hand, the area of the cladding zone that immediately follows the trench 5 closest to the core, and thus that is not directly in contact with the core, is hereinafter referred to as secondary cladding. The secondary cladding is thus bounded by at least one trench on the inside and a further trench on the outside.

In this embodiment, therefore, the core also has the highest refractive index over its entire gradient profile, whereby the refractive indices of the individual trenches decrease with increasing radius R. It is thus:

n_{core}≧nₘₐₜᵣᵢₓ>n_{trench1}>n_{trenchN} where N=2, 3, 4

The diagram shown in FIG. 2 for a farther embodiment corresponds in its basic structure to the embodiment of FIG. 1. Therefore, for clarity, no reference signs are included. In the embodiment of FIG. 2, the core has considerably higher refractive index and is correspondingly doped higher. This has the advantage that the numerical aperture can be increased in this case, which is, for example, for optical waveguides, very significant for optical image transfer.

To obtain the refractive index profile indicated in FIGS. 1 and 2, a positively graded core that is produced with the help of the known modified chemical vapor deposition process (modified chemical vapor deposition method—MCVD) and directly coated by means of an outside vapor deposition outside vapor deposition method—OVD). The trench structures can be achieved by the adjunction of a suitable concentration of dopants, whereby the doping adjunction can preferably be alternately activated and deactivated.

Further advantageous embodiments are shown in FIGS. 3, 3a, 3b and 4. In these embodiments, the secondary cladding within the step 6 does not have the reference level is n=0, but a rather higher refractive index value. So it is doped to obtain an increasing effect on the refractive index.

in the embodiment of FIG. 3, the secondary cladding within the steps shows a refractive index value that is independent of the radius. Further advantageous embodiments are shown in FIGS. 3a and 3b. In these embodiments, the secondary cladding does not have the reference level of the glass matrix, but increases to a higher refractive index value. This higher refractive index value is constant between the trenches in the embodiment of FIG. 3a, and therefore has a rectangular profile shape. In contrast, the higher refractive index value in the embodiment of FIG. 3b is gradual, in particular parabolic, in shape.

In the embodiment of FIG. 4, the refractive index value of the secondary cladding increases with the radius. The increase can be applied linearly, but also non-linearly. The rectangular profile curve in the secondary cladding can also be designed gradually as in FIG. 3b.

The embodiments of FIGS. 3 to 4 are advantageous for passive fibers where only one optical waveguide is required and where neither an optical excitation nor an optical pumping process is required. The refractive index profile within the secondary cladding ensures that in the case of these fibers, the proportion of the light which leaves the core is not propagated back into the core but tends to be directed outwards, while the propagation directions are blocked at the core by total internal reflection effects. This effect is thus important because by these means a high signal quality can be achieved while subsequent modes can be masked.

The embodiments shown in FIGS. 3 to 4 are interesting, however, not only liar purely passive optical waveguides. The design of the refractive index profile of the optical waveguide means that it is possible in particular to transfer light that has been fed into the core into the secondary cladding, so that, for example, a ring-shaped distribution of the radiation results at the output of the optical waveguide. In such a case, the secondary cladding acts as a secondary optical waveguide in which additional optical processes may optionally be activated. So, in principle, it is possible to introduce laser-active ions in these secondary optical waveguides. An inverse excitation can be performed in such a case. In this way, pumped light can be fed to the core. The pumped light propagates in the secondary optical waveguide and effects the conversion there.

The following procedure is considered, for example, to produce the designs illustrated in FIGS. 3 to 4. First, a fluorine-containing layer is deposited on the inner surface of a substrate tube. Then the inner core is produced through successive substitution of fluorine by germanium. This is then collapsed, and the outer substrate tube is subsequently removed. Then a further substrate tube is produced. A uniform or graded germanium-doped layer is deposited inside this additional substrate tube. The substrate tube is then removed, and at least one fluorine-doped layer is deposited outside by means of an OVD method. Subsequently, the second tube thus prepared is collapsed on the core rod formed by the first tube. These steps involving inner substrate tube coating, removal of each substrate tube and collapsing can be repeatedly performed, so that the desired refractive index profile is formed in the resultant preform.

In the previously presented embodiments, the refractive index profile of the core at the interface with the cladding region first passes via the area of a step of the primary cladding, in which the refractive index is the same as that of the quartz matrix. In this case, the curve of the refractive index profile within the core is smooth, i.e., for example, either in the form of a parabola, or constant.

In the embodiments illustrated in FIGS. 4a and 4b, the refractive index core profile I is already interrupted by an inner core trench structure consisting of at least one trench. In this case, there can be a reduction in the trench levels either to the reference level, as shown in the embodiment in FIG. 4a, or even lower, as shown in the embodiment in FIG. 4b.

But it is also possible that the refractive index profile of the care passes directly into a trench, or that the trench itself cuts the refractive index profile at the edge of the core. In such a case, therefore, there is no primary. cladding. The embodiments of FIGS. 5 and 6 show corresponding examples. FIG. 5 shows an embodiment where there is as constant refractive index within the core 2. In the embodiment of FIG. 6, there is a refractive index gradient in the core. The refractive index abruptly falls to a first minimum value at the first trench at the boundary between the core and the cladding zone. This jump defines the boundary between the core and cladding zone of the optical waveguide that is significant for the optical waveguide. From a technical manufacturing point of view, this first trench, however, can also be constructed as part of the core. In such a case, the core is doped with a surface treatment method in such a way as to produce a significant refractive index decrease on the surface, which, however, can only be detected on the surface of the core and does not affect the depth of the core.

In further embodiments, the refractive index transition from the core to the primary cladding takes place via a step-index profile. Here, the core level is at the height of the reference levels as shown in the embodiment according to FIG. 6a or more so as shown in the embodiment according to FIG. 6b.

In the embodiment according to FIG. 6a, the core thus consists of the fused quartz glass matrix itself, or at least of a material with the same refractive index. Therefore, there is no distinction between the core and the primary cladding in that sense. In this embodiment, the light guide within the core is only substantially effected by lowering the refractive index within the trench structures in the cladding zone.

FIGS. 6c and 6d show the respective embodiments in which the core is immediately adjacent to a trench, and whereby a primary cladding is not present.

For the preparation of the illustrated construction, F-doped or Ge-doped layers may be deposited in the interior of a substrate tube, so that the desired stepping through the core or the corresponding gradient of the refractive index is obtained. Subsequently, the outer substrate tube is removed, followed by an OVD coating of the core with corresponding doped layers in the sequence of the desired refractive index gradient.

The embodiment shown in FIG. 7 differs from the previously illustrated embodiments in that the trench fine structuring shown here is very thin, and closely spaced trenches are provided. The decrease in the refractive index over the trench profile is therefore characterized by a relatively small radius area, and is thus generally relatively rapid. In addition, primary cladding is not available. The core passes over the interface to the cladding zone in a trench. Because the trenches are very narrow with a width that is much smaller than the wavelength of the light transported within the optical waveguide, this trench structure does not act as an element for a Bragg reflection, but causes a quasi-continuous decrease in the refractive index within the cladding region. The embodiment according to FIG. 7 describes a way whereby the refractive index can be considerably lowered in the middle of the cladding zone, while the entire surface area does not have to be doped.

The embodiment according to FIG. 8 shows a refractive index profile within the cladding zone 4, wherein first the refractive index inside the cladding is lowered compared to the refractive index of the quartz matrix by a constant amount dn, so that it is negative in relation to the reference refractive index. Secondly, this trench structure is additionally superimposed via this constant negative refractive index.

In this case, the innermost trench profile directly adjoins the core without primary cladding. The secondary cladding therefore has a refractive index level below the level of the reference matrix; n<0. This allows very high NA values to be achieved. The bending sensitivity in this case is particularly good.

In the manufacture of this embodiment, fluorine is steadily added in varying amounts for the doping during the OVD coating of the core.

The bending sensitivity can be further set specifically by effecting a triple gradation as shown in the embodiment according to FIG. 9. In this case, the core refractive index profile forms a first gradation, the maximum trench depth a second, and the height of each of the secondary claddings following the trench a third parabolic-like gradation. The individual gradients can be adapted to one another in an embodiment in their form (parabolic parameters inclination, geometry), or completely independently from one another. Thus in one embodiment with high core doping, a strong core gradient is provided, whereas the gradation of the maximum trench depth is less pronounced. This design allows a very fine adjustment of the bending sensitivity.

The embodiment of FIG. 9 corresponds essentially to the embodiment of FIG. 8. In this embodiment, the trench structure is so designed that a step 6a of the secondary cladding does not have negative refractive index within the trench structure, but is on the level of the refractive index of the quartz glass matrix. With such a configuration, it is possible to selectively decouple sonic light components from the core and then couple them again with guided light components within the cladding zone in the direction of the core, and thus obtain an end effect of a wavelength-dependent intensity distribution over the cladding zone.

The production of the refractive index profiles of the embodiments according to FIGS. 8 and 9 can be obtained in a simple manner by modification of the previously described steps.

In addition to the refractive index of the trench structures, the width of the trenches as well as their spacing can also be used as further design parameters. FIGS. 10 through 13 show respective embodiments. In these embodiments, the trench depth remains constant over the radius n_{trench}=const. In the embodiment of FIG. 10, the distances d1, d2 and d3 between the trenches are not held constant, but vary depending on the radius R. In this embodiment, the spacing increases across the radius. The trench fine structuring caused by the lamellar structure is determined by the sparing of the trenches from one another as well as the distances between the trenches.

The embodiment according to FIG. 11 essentially corresponds to the embodiment according to FIG. 10, so a repetition of the reference numerals is omitted. The embodiment of FIG. 11 differs from the embodiment shown in FIG. 10 in that the core area does not directly open into a trench area, but that the core is surrounded by an area 6b of an unaffected cladding, material in the form of the primary cladding.

In the embodiment according to FIG. 12, the trench width g also varies depending on the radial position of the respective trench, while the distances between the grooves remain constant. In the embodiment according to FIG. 13, the trench distances d also change likewise. In contrast to the embodiment according to FIG. 11, these decrease with increasing radius.

In the case of different wavelengths, light undergoes strong varying interaction varying with the trench structuring due to the varying trench widths in conjunction with the varying trench distances. Therefore, while the wavelength mainly depends on the penetration depth supporting it, interference effects and Bragg reflections also play a role. Accordingly, a preferential wavelength is formed outside the individual trench structures enabling a wavelength selection to be obtained. In the case of these embodiments, a particularly strong Bragg reflection may result compared to the other embodiments. This is of particular importance especially for optical waveguides used in censors.

The individual trenches can also be connected to one another almost directly. Corresponding examples are shown in the FIGS. 14 and 15. In the embodiments shown here, the discrete trenches are only separated from one another by a very thin strip of matrix material. The trench widths are large relative to the interposed matrix material, especially 10 times greater. The zones between the trenches have a small thickness; in particular, this thickness is smaller than the wavelength of the propagated light within the core. Thus, these spaces play practically no role in the interference processes within the trench structure of the cladding zone. The refractive index values of the individual trenches may either fall or increase depending on the radius.

In the embodiment according to FIG. 14, the trench located closest to the core has the highest refractive index. The following applies:

n_{core}>n_{trench1}

and further

n_{trenchN}≧n_{trenchN+1}

In the embodiment according to FIG. 1 and in the embodiment according to FIG. 15a, the following also applies:

n_{core}≧n_{trench1},

where the following applies within the sequence of the trenches:

n_{trenchN}≦n_{trenchN+1}.

For this embodiment, the same variation possibilities apply with respect to the trench depth, trench width, the height of the reference level and the number of trenches, as in the previously described embodiments. This design has particular advantages with respect to the mode selection and bending optimization.

It is likewise provided in one embodiment that one of the central trenches has a minimum value. FIGS. 27 and 28 show such an embodiment. There may also be a separation of the individual trenches by means of an interim increase in the matrix level.

The trenches of the above-mentioned embodiment can have a fine structure in the form of a gradation. FIG. 16 shows a section of this, with an enlarged view of the refractive index gradient inside a trench. In contrast to the rectangular shape of the refractive index profile in the trench area, the refractive index profile of a minimum of the trench structures extends along a grading line 7, which is here configured as part of an envelope 8. Thus the envelope describes the overall profile of the refractive index over the trench structure depending on the radius of the optical waveguide. The grading line here is a direct section of the envelope on the respective trench area. In general, however, the two curves must not be identical.

FIG. 17 shows an embodiment with a stepped gradation of a trench. The grading line here is a step function. Such a refractive index profile can also be achieved where the trenches immediately follow one another without any spacing. In this case, the embodiment according to FIG. 17 is a special case of the embodiment shown in FIG. 14, which can diverge from one another and whose design is dependent on the manufacturing process.

In further embodiments according to the FIGS. 18 and 19, the trenches have a gradation, whereby the minimum level of each trench has a parabolic shape. The envelope 8 in FIG. 18 is a downwardly open parabola, while the grading line 7 in each trench on the other hand is an upwardly open U-shaped curve, in particular a parabolic or a circular segment.

With such a configuration, a very large and wide fine adjustment of the bending sensitivity of the optical waveguide can be achieved. In the embodiment according to FIG. 19, in addition the refractive indexes of the intermediate layers of the glass matrix of the secondary cladding 6 following the trenches are likewise graded by a downwardly open parabola grading line. This ideally forms a lamellar structure composed of layers with a steep but smooth oscillating refractive index profile.

In further embodiments, as shown in FIGS. 20 and 21, the trenches are formed as pointed profiles 9. As shown in FIG. 20, the gradation of the trenches may be equal to the gradient or as shown in FIG. 21, it may be different, it is also possible to combine the different forms of trench.

FIGS. 22 and 23 schematically show an example of a front view of the trench structures. In the embodiment according to FIG. 22, the trench width is constant, while it varies in the embodiment of FIG. 23 and increases at larger radii.

In the case of active fibers that are to be used in particular for pumping stimuli, efficient mode mixing is necessary. This can be achieved for example by at least sectional recesses 10 in individual layer structures as shown as an example in FIGS. 24 and 25. Through the at least partially at least sectional recess, for example, the lamellar structuring according to one of the previous embodiments can be changed in such a way that a degeneration of the optical mode in the lamellar structure is avoided

The electromagnetic wave propagating in the fiber can be influenced by this dependence on direction. For example, polarization maintaining structured fiber can be thus produced whose bending sensitivity can be varied as required.

Such recesses can be obtained by cladding steps of a suitable rod with a tube having the desired refractive index profile and which has at least sectional recesses.

It goes without saving that the following lamellar structures may be disturbed in their centrosymmetry. These disturbances are desirable in some cases of mixed modes, while they must be compensated for in sonic cases.

FIG. 30 shows a refractive index trench profile 3 with a graded trench structure in conjunction with a graded refractive index core profile 1. The refractive index, core profile opens into a step 6 in the transition from the core 2 to the cladding region 4. whose relative refractive index Δn=0, i.e., whose refractive index p corresponds to the glass matrix. The first trench within the cladding zone has a graded flank 11. This forms a displaced continuation of the refractive index profile in the refractive index core profile at the step 6. The depth of the trench is about −6.5·10⁻³, the width of the trench is in the range of about 5 μm, while the width of the step 6 is in the range of about 1 μm.

FIG. 31 shows a first embodiment with reference to an exemplary refractive index profile. In a diagram, the refractive index profile shows the curve of the relative refractive index Δn depending, on the radius R of the optical waveguide. The relative refractive index is standardized to the reference value of an unaffected quartz glass matrix. Positive values of Δn thus give an increased refractive index relative to this value, while negative values indicate a decreased refractive index relative to the reference value in the respective area of the radius. The influencing of the refractive indices is achieved by doping. Refractive index reductions can be obtained by doping with halogens, especially fluorine, refractive index increases by doping the quartz glass matrix, far example, with germanium, aluminum or phosphorus.

The refractive index profile includes two large areas. This is a core zone 2 and a cladding zone 4 of the optical waveguide The core area forms the actual light guiding area, the cladding zone a so-called cladding. The optical fiber can be both a single mode fiber and a multi-mode fiber.

The core area has a gradual refractive index profile, in this case, the refractive index in the core decreases from a maximum value at R=0 at the center of the core in an approximately parabolic shape to the cladding zone. The cladding zone includes, on the other hand, a refractive index trench profile 3 from a concentric series of areas extending outwardly and having negative relative refractive indices. These areas are referred to as trenches. The intermediate areas of the cladding zone form steps or intermediate steps.

Only two trenches are shown in the present example for reasons of simplicity. The innermost trench 16 has a trench flank 15 oriented backwards towards the core zone. This forms a continuation of the gradual refractive index profile 1 within the core zone. This curve does not, however, adjoin the gradual refractive index profile, but is interrupted by an intermediate step 17. This intermediate step adjacent to the core zone has a relative refractive index of Δn=0. It thus consists of uninfluenced and especially undoped quartz glass matrix material. The widths a and b of the trenches are each about 1 to 3 μm. The width of the intermediate stage 17 is approximately 0.5 to 1.5 μm. It can also be substantially as wide as the subsequent inner trench 6. The innermost trench has a depth of Δn=−(6.5±0.5)·10⁻³.

FIG. 32 shows a further embodiment. The core zone 2 here likewise shows a graded refractive index profile 1. The cladding zone 4 likewise has the refractive index trench profile 3. An inner trench 16 and an outer trench 18 are provided. The inner trench 16 is separated from the core zone by an inner intermediate step 17 and the outer trench S by an outer intermediate step 19. In the example illustrated here, the refractive index profile within the core zone does not discontinue on one of the flanks of the inner trench 16. The core zone has a radius d where, for example, d=25±1 μm. The height of the relative refractive index at the center of the light wave conductor is Δn0=(2.0±0.2)·10⁻³. The width of the intermediate step 7 is, for example, e=1.5±1.0 μm; the width of the inner groove 16 is approximately a=3±2 μm. The relative refractive index of the inner trench is about Δn2=−(9±3)·10⁻³. The width of the intermediate stage 17 and that of the inner groove 16 are in the present example such that these together amount to a+b=5±2 μm.

In the present example, the outer trench 18 is substantially as wide as the inner trench 16, but has a slightly smaller depth. The intermediate step 19 arranged between the two trenches is approximately as wide as each of the trenches, and has a positive relative refractive index Δn2>0.

FIG. 33 shows a further embodiment. In this case. the refractive index profile I of the core zone passes smoothly into the inner flank 15 of the inner trench 6. The inner trench 6 is surrounded by an outer trench 18. The intermediate stage 19 arranged between them is positive and has it width of e=0.5±0.2 μm, and a relative refractive index of Δn2=(1±0.3)·10⁻³.

The inner trench 6 is approximately a=1.5±0.6 μm wide, and has a relative refractive index of Δn1=−(2±0.5)·10⁻³. This width is supplemented with that of the intermediate step 9 to give a total width of a+c=1 μm. The outer trench 18 is significantly wider than the inner trench 16. It has a width of approximately b=3±2 μm, and a relative refractive index of Δn3=−(9±3)·10⁻³. It is thus at least 3 times “lower.”

The radius of the core zone 1 in this example is d=20 to 30 μm, the relative refractive index within the core zone at the center is positive and has a value, of about Δn0=(2.0±0.2)·10⁻³.

FIG. 34 shows an example of a section of a lamellar preform. To some extent, this section forms a basic form of a core, a step and an inner trench. In this case, this basic form can be supplemented with additional outer trenches. The core zone 2 here has one graded refractive index profile 1. The cladding zone 4 also has the refractive index trench profile 3. An inner trench 16 is provided. A lamellar structure adjoins on the outside, and is of such a design that it is independent. The inner trench 16 is separated from the core zone by an inner intermediate step 17. This structure adjoins further trenches, via which the fine adjustment of the bend sensitivity can be performed.

In this example, Δn0=(2.05±0.12)·10^{31 3}. The core radius d is, for example, d=25±1 μm. The width of the intermediate step 17 in this example is about e=1.8±1.6 μm. The width of the trench 16 is approximately a 3±2 μm, the depth Δn1=(9±3)·10⁻³. The sum of the two lines a and e is for example 6±2 μm.

The global description of the refractive index trench structures in the preceding embodiments within the cladding or the fiber cladding can refer back to zone functions. The principle is exemplified in the following figures.

FIG. 35 shows an exemplary zone function 20 for the global calculation and presentation of the refractive index trench profile within the cladding or the fiber cladding, with an upper envelope 21 and a lower envelope 22 in the Δn;R diagram. The zone function is shown here as a periodic rectangular function. Its periodicity directly forms the sequence of individual trenches within the cladding zone. An oscillation period is described by the length L. This period length forms a type of lattice constant for the refractive index trench profile. It can itself be dependent of the radius R. In this way, it expands or narrows the sequence of square wave periods within the zone function. The zone function begins at a finite radius R_{core}. This size corresponds to the radius of the fiber core or of the preform to produce the optical fiber.

The zone function may be modified as desired, and in particular may have an exponential, polynomial, parabola-like curve or the curve of a power function.

Of course, the zone function can be shifted by additive negative or positive offsets along the ordinate, as shown in the example according to FIG. 35a.

FIG. 36 shows an exemplary modulation of the zone function, which is performed in this example through the lower envelope curve 22. The lower envelope curve decreases with increasing radius, the upper envelope remains constant. The trenches described by the zone function thus increase with increasing radius of the preform or fiber. The zone function in this example is am at a finite radius R_{core}.

A lower envelope curve, which increases with increasing radius, is shown in FIG. 35a.

The shape of the zone function is not limited to rectangular shapes, although rectangular shapes can be produced relatively easily as trench structures in the preform. FIG. 37 shows an example of a sawtooth function zone 23, which is enclosed between an upper and a lower envelope curve. The period length L corresponds here to the distance between two spikes within the saw-tooth sequence. The zone function shown in FIG. 37 can be modulated in a similar manner as the zone function in FIGS. 35 and 36.

The function values to be obtained from the zone function can be derived via a control unit in a device for the production and processing of a preform. This enables, fur example, the operation of a plasma coating system, in particular to control the gas and material mixture applied to the glass blank, thus transferring the desired refractive index profile directly to the real refractive index profile of the preform and forming it really there.

The invention has been explained with reference to exemplary embodiments. Further embodiments are possible under the control of persons skilled in the art. This is demonstrated in particular in the dependent

### REFERENCE LIST

1 Refractive index core profile
2 Core
3 Refractive index trench profile
4 Cladding zone
5 Trench
6 Step
6a Step with increased refractive index
6b Primary cladding
7 Graded line
8 Envelope curve
9 Point profile
10 Recess, interruption

1. Optical waveguide and preform for the production of an optical waveguide with bending optimized properties, containing
a trench fine structuring with radius-dependent gradient-type of refractive index profile (1) and/or a concentric refractive index trench profile (3) within a core zone (2) and/or within a cladding zone (4).

2. Optical waveguide and preform according to claim 1, wherein
the trench fine structuring is formed of a sequence of differently doped zones, with refractive index lowering and/or refractive index increasing dopants within a basic matrix.

3. Optical waveguide and preform according to claims 1,
wherein
the basic matrix is a quartz glass matrix and the dopants are elements of the seventh main group, rare earth elements, metals, semi-metals and/or transition elements and/or compounds of the said elements, preferably compounds consisting of the elements, at least partially: Si, Ag, Au, Cu, Ni, Ta, Zr, Sn, Zn, Hg, Ru, Rh, Ir, Os, Ro, W, Ti, Al, In, Ga, Nb, La, Sm, Ce, B, P, Sr, Ba, Mo, Cr, Fe, Co, Se, Mn, Ge, V, In, Bi, Pt, Pd, Tc, V, Pb, N.

4. Optical waveguide and preform according to claim 1,
wherein
the refractive index modulation of the refractive index trench profile is a function of the depth varying over the radius.

5. Optical waveguide and preform according to claim 4,
wherein
the variation of the refractive index trench profile is modulated rectangularly and/or graded.

6. Optical waveguide and preform according to claim 1,
wherein
the refractive index trench profile has direction-dependent interruptions and/or recesses.

7. A process for producing an optical waveguide or a preform for an optical waveguide with optimized bending properties,
comprising the steps of
providing a matrix consisting of a quartz glass core and doping the core with refractive index changing dopants to form a refractive index core profile,
use of an outer coating method to apply a core coating with a shell-shaped doping profile.

8. A process for producing an optical waveguide or a preform for an optical waveguide with optimized bending properties through repeated collapsing,
comprising the steps of
providing a first substrate tube,
depositing a first coating inside the substrate tube to form a core,
collapsing the substrate tube and removing the first substrate tube,
providing a further substrate tube and depositing a doped layer in the interior of the further substrate tube and/or from the outside,
removing or maintaining the further substrate tube and collapsing the doped layer on the core,
collapsing or depositing further layers.

9. A process for producing an optical waveguide or a preform for an optical waveguide with optimized bending properties,
comprising the steps of
providing a substrate tube,
successively depositing differently doped layers in the interior of the substrate tube to form a core,
removing the substrate tube, and exposing the core,
successively coating the core by depositing differently doped outer layers.

10. Method according to claim 7,
wherein
the collapsing and/or depositing is performed using substrates provided with recesses.

11. A process for producing an optical waveguide or a preform for an optical waveguide with optimized bending properties,
wherein
the inner and/or outer coatings are applied using OVD, preferably POVD techniques, flame burners, smokes and/or CVD, preferably MCVD techniques.

12. Optical fiber and preform according to claim 1,
wherein
the sequence of the fine structure forms a lamellar structure.

13. Optical fiber and preform according to claim 1,
wherein
there are at least two distinguishable refractive index lowering areas.

14. Optical fiber and preform according to claim 1,
wherein
the radial width of at least one of the structures corresponds approximately an integral fraction of the wavelength used later, preferably aλ/2 or aλ/4 where (a=1, 2, 3 . . . ).

15. Optical fiber and preform according to claim 1,
wherein
it is used as a bending-sensitive fiber, sensor fiber, active laser fiber, fiber with wavelength-selective properties, fiber within an optical unit.

16. Optical fiber and preform according to claim 1,
wherein
the refractive index profile of the core region continues to a flank (15) oriented towards the core zone of at least one of the innermost trenches (16) of the refractive index trench structure closest to the core zone, where the refractive index curve between the core zone and the innermost trench has at least one intermediate step (17).

17. Optical fiber and preform according to claim 1,
wherein
the refractive index profile of the core region continues to a flank (15) oriented towards the core zone of at least one of the innermost trenches (16) of the refractive index trench structure closest to the core zone, where the refractive index profile between the innermost trench and a trench (8) following the innermost trench radially outward has at least one intermediate step (19).

18. Optical fiber and preform according to claim 1,
wherein
the refractive index gradient between the core zone and the innermost trench has at least one intermediate step (17).

19. Optical fiber and preform according to claim 16,
wherein
the intermediate step (17, 19) has a value at the refractive index level of the glass matrix of the optical waveguide.

20. Optical fiber and preform according to claim 16,
wherein
the intermediate step (17, 19) has a value higher than the refractive index level of the glass matrix of the optical waveguide.

21. Optical fiber and preform according to claim 1,
wherein
the refractive index values of the innermost trench (16) and at least the next subsequent trench (18) decrease with increasing radius.

22. Optical fiber and preform according to claim 1,
wherein
the upper envelope curve in the area of the outer zone has a constant, decreasing or increasing curve while the lower envelope in the area of the outer zone has a linear, preferably constant, or gradual curve.

23. Optical fiber and preform according to claim 1,
wherein
the oscillating function zone within the cladding zone has an oscillating rectangular profile in the radial direction.

24. Optical fiber and preform according to claim 1,
wherein
the oscillating function zone within the cladding zone has an oscillating sawtooth profile in the radial direction.

25. Optical fiber and preform according to claim 1,
wherein
the oscillating zone function within the cladding zone has an oscillating sinusoidal curve in the radial direction.

26. Method according to claim 8,
wherein
the collapsing and/or depositing is performed using substrates provided with recesses.

27. Method according to claim 9,
wherein
the collapsing and/or depositing is performed using substrates provided with recesses.
